(19) United States
(12) Patent Application Publication
(10) Pub. No.: US 2016/0117059 A1
(43) Pub. Date: Apr. 28, 2016

(54) User Interface for Fleet Management

(71) Applicant: Caterpillar Inc., Peoria, IL (US)

(72) Inventors: Keith Folken, West Peoria, IL (US); Girish Revankar, Thane (IN); Madhavan Babu, Chennai (IN); Praveen Rajendran, Chennai (IN); Murthy RT, Chennai (IN); Prakash Kasiviswanathan, Chennai (IN)

(73) Assignee: Caterpillar Inc., Peoria, IL (US)

(21) Appl. No.: 14/588,516

(22) Filed: Jan. 2, 2015

Related U.S. Application Data
(60) Provisional application No. 62/068,488, filed on Oct. 24, 2014.

(51) Int. Cl. G06F 3/0482; G06Q 10/06; G06F 3/0484; G06F 3/0483; G06F 3/0481

(52) U.S. Cl. CPC G06F 3/0482; G06F 3/0483; G06F 3/04817; G06F 3/04847; G06Q 10/0631

(57) ABSTRACT

A user interface is provided for a fleet management web portal for a manufacturer, operator, or user to manage a fleet of equipment and/or machines. The fleet of equipment and/or machines may be linked with the fleet management web portal and the manufacturer, operator, or user may access alerts and other information associated with the equipment and/or machines using an electronic device. The user interface is compatible with electronic devices of various sizes and enables a user to interact with information associated with fleet of equipment and/or machines.

### CROSS-REFERENCE TO RELATED APPLICATION

This patent application claims the priority benefit of U.S. Provisional Patent Application No. 62/068,488, filed Oct. 24, 2014, which is incorporated herein in its entirety by this reference.

### TECHNICAL FIELD

The disclosure relates generally to a user interface for a management solution and more particularly to a user interface for a fleet management web portal.

### BACKGROUND

Fleet operators may employ logs or records to keep track of a location or service records of their machines and equipment. In instances where operators need to manage a large fleet of machines and equipment, operators may employ data systems to manage the fleet within a user interface.

U.S. Patent Application Publication 2002/0178147 to Arroyo et al. discloses a user interface for organizing service jobs for a fleet of vehicles. However, the user interface of Arroyo et al. generally displays textual information in a grid format which may be difficult to read or navigate, especially when displayed on a small screen or a mobile device. Accordingly, there is a need for an improved graphical user interface.

### SUMMARY

In one aspect, the disclosure describes a display device for displaying a graphical user interface of a fleet management system. The graphical user interface includes a first screen configured to display a first panel including equipment information. The first screen includes one or more selection tabs or links configured to access at least a second screen, the second screen being configured to facilitate management of one or more pieces of equipment associated with the fleet management system. The first panel is configured to display equipment summary information.

In one aspect, a computer-implemented method displays a fleet management system through a user interface. The method includes retrieving information from one or more pieces of equipment associated with the fleet management system. The method includes generating a first screen to display a first panel including equipment information. The method includes generating a first screen to display one or more selection tabs or links configured to access a second screen to facilitate management of one or more pieces of equipment associated with the fleet management system. The first panel displays equipment summary information.

### BRIEF DESCRIPTION OF THE DRAWINGS

FIG. 1 shows a user interface for an alert section of a home screen page of a fleet management web portal according to an aspect of the disclosure.

FIG. 2 shows a user interface for an alert section of a home screen page of a fleet management web portal with alerts populated according to an aspect of the disclosure.

FIG. 3 shows an enlarged portion of the user interface of FIG. 2.

FIG. 4 shows an exemplary alert icon and text for the user interface of FIG. 2.

FIG. 5 shows an exemplary alert icon and text for the user interface of FIG. 2.

FIG. 6 shows an exemplary alert icon and text for the user interface of FIG. 2.

FIG. 7 shows an exemplary alert icon and text for the user interface of FIG. 2.

FIG. 8 shows an exemplary alert icon and text for the user interface of FIG. 2.

FIG. 9 shows an exemplary alert icon and text for the user interface of FIG. 2.

FIG. 10 shows an exemplary alert icon and text for the user interface of FIG. 2.

FIG. 11 shows an exemplary alert icon for the user interface of FIG. 2.

FIG. 12 shows an exemplary alert icon for the user interface of FIG. 2.

FIG. 13 shows an exemplary alert icon for the user interface of FIG. 2.

FIG. 14 shows an exemplary alert icon for the user interface of FIG. 2.

FIG. 15 shows an exemplary alert icon for the user interface of FIG. 2.

FIG. 16 shows an exemplary alert icon for the user interface of FIG. 2.

FIG. 17 shows an exemplary alert icon for the user interface of FIG. 2.

FIG. 18 shows a user interface for a home screen page of the fleet management web portal with a fault codes side panel displayed according to an aspect of the disclosure.

FIG. 19 shows a user interface for an equipment summary page according to an aspect of the disclosure.

FIG. 20 shows an exemplary equipment icon for the user interface of FIG. 19.

FIG. 21 shows an exemplary equipment icon for the user interface of FIG. 19.

FIG. 22 shows exemplary equipment icons for the user interface of FIG. 19.

FIG. 23 shows a user interface for an alternative equipment summary page including filters according to an aspect of the disclosure.

FIG. 24 shows a user interface for an alternative equipment summary page including a list of equipment according to an aspect of the disclosure.

FIG. 25 shows a user interface for a second alternative equipment summary page according to an aspect of the disclosure.

FIG. 26 shows a user interface for an alert page according to an aspect of the disclosure.

FIG. 27 shows a user interface for an equipment fault codes page according to an aspect of the disclosure.

FIG. 28 shows a user interface for an equipment utilization page according to an aspect of the disclosure.

FIG. 29 shows a user interface for an equipment operations history page according to an aspect of the disclosure.

FIG. 30 shows a user interface for an equipment details page including fault codes according to an aspect of the disclosure.

FIG. 31 shows a user interface for an equipment details page including tracking points according to an aspect of the disclosure.

FIG. 32 shows a user interface for an equipment details page including load percentage utilization according to an aspect of the disclosure.

FIG. 33 shows a user interface for an equipment details page including load percentage utilization with displayed calculations according to an aspect of the disclosure.

FIG. 34 shows a user interface for an equipment details page including an equipment location input dialog according to an aspect of the disclosure.

FIG. 35 shows a user interface for a geographic boundary page according to an aspect of the disclosure.

FIG. 36 shows a user interface for a manage alert rules page according to an aspect of the disclosure.

FIG. 37 shows a user interface for a create alert rule page according to an aspect of the disclosure.

FIG. 38 shows a user interface for a create alert rule page with a severity level selection according to an aspect of the disclosure.

FIG. 39 shows a user interface for a create alert rule page with a customization pop-up window according to an aspect of the disclosure.

FIG. 40 shows an enlarged portion of the user interface of FIG. 39.

FIG. 41 shows a user interface for a create alert rule page with an error message according to an aspect of the disclosure.

FIG. 42 shows a user interface for a create alert rule page with equipment selection according to an aspect of the disclosure.

FIG. 43 shows a user interface for a create alert rule page with add recipient selection according to an aspect of the disclosure.

FIG. 44 shows a user interface for a confirmation alert rule page according to an aspect of the disclosure.

FIG. 45 shows a user interface for a create alert rule page with a geo boundary selection according to an aspect of the disclosure.

FIG. 46 shows a user interface for a create alert rule page with an engine status selection according to an aspect of the disclosure.

FIG. 47 shows a user interface for a create alert rule page with a device status selection according to an aspect of the disclosure.

FIG. 48 shows a user interface for a create alert rule page with a battery voltage alert selection according to an aspect of the disclosure.

FIG. 49 shows a user interface for a create alert rule page with a power loss alert selection according to an aspect of the disclosure.

FIG. 50 shows a user interface for a create alert rule page with a battery voltage threshold column according to an aspect of the disclosure.

FIG. 51 shows a user interface for a create alert rule page having a configuration sub-window with a first option selected according to an aspect of the disclosure.

FIG. 52 shows a user interface for the device configuration sub-window of FIG. 43 with a second option selected according to an aspect of the disclosure.

FIG. 53 shows a user interface for the device configuration sub-window of FIG. 43 with a third option selected according to an aspect of the disclosure.

FIG. 54 shows a user interface for a manage view assignment page according to an aspect of the disclosure.

FIG. 55 shows a user interface for a view assignment page with equipment selections according to an aspect of the disclosure.

FIG. 56 shows a user interface for a view assignment page with selected equipment according to an aspect of the disclosure.

FIG. 57 shows a user interface for a view assignment page with an expiration date option according to an aspect of the disclosure.

FIG. 58 shows a user interface for a date selection interface associated with a view assignment page according to an aspect of the disclosure.

FIG. 59 shows a user interface for a view assignment page with a user selection according to an aspect of the disclosure.

FIG. 60 shows a user interface for a view assignment page with a populated assigned viewers list according to an aspect of the disclosure.

FIG. 61 shows a user interface for a view assignment confirmation page with a user viewer type according to an aspect of the disclosure.

FIG. 62 shows a user interface for a view assignment confirmation page with a dealer viewer type according to an aspect of the disclosure.

FIG. 63 shows a first aspect of a user interface for a view assignment page with a view assignment selected according to an aspect of the disclosure.

FIG. 64 shows a second aspect of a user interface for a manage view assignment page with a view assignment selected according to an aspect of the disclosure.

FIG. 65 shows a third aspect of a user interface for a view assignment page with a view assignment selected according to an aspect of the disclosure.

FIG. 66 shows a user interface for a manage view assignment page according to an aspect of the disclosure.

FIG. 67 shows a user interface for an advisor subscription page according to an aspect of the disclosure.

FIG. 68 shows a user interface for a fleet view page including asset details according to an aspect of the disclosure.

FIG. 69 shows a user interface for a fleet view page including alert information according to an aspect of the disclosure.

FIG. 70 shows a block diagram of an exemplary fleet management system according to an aspect of the disclosure.

FIG. 71 shows a schematic diagram of an exemplary computer system according to an aspect of the disclosure.

### DETAILED DESCRIPTION

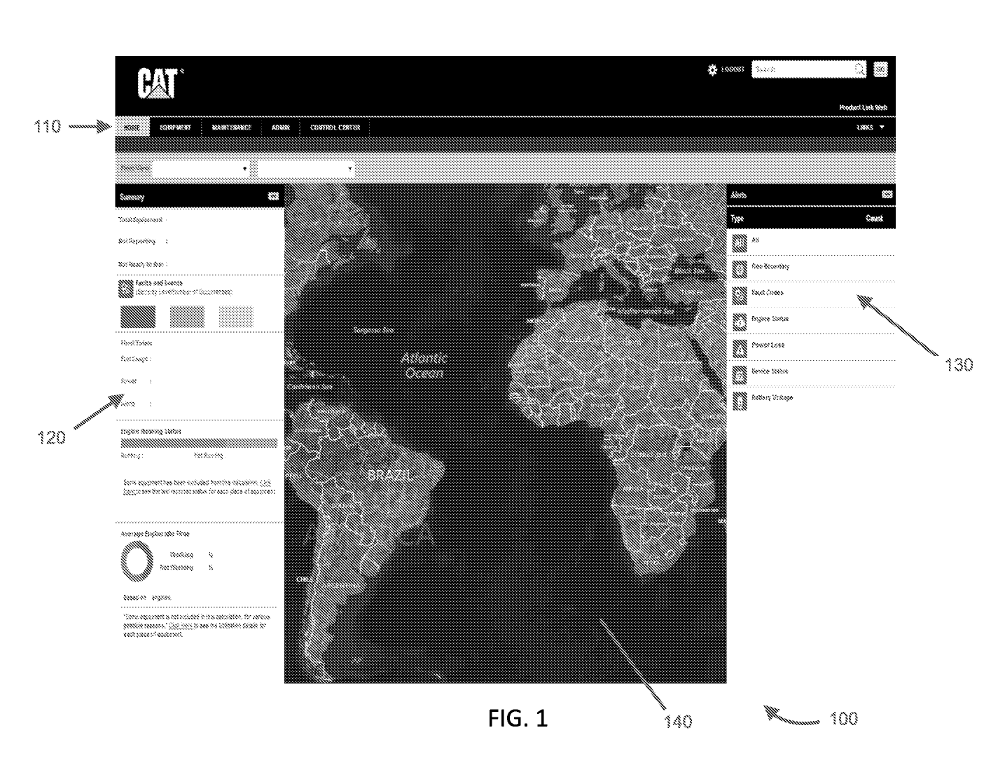

Now referring the drawings, wherein like reference numerals refer to like elements, FIG. 1 shows a general graphical user interface layout for a home screen page 100 of a management solution portal or a fleet management web portal. The fleet management web portal may include an interactive interface and/or database which may be hosted on one or more servers located at one or more sites. The fleet management web portal may be used to store, receive and/or distribute data and information relating to a single piece of machine or equipment, a fleet of machines and equipment, or a plurality of fleets of machines and equipment associated with one or more parties. The fleet management web portal may enable operators to access up-to-date and relevant information relating to their equipment to improve operating efficiency and to reduce cost. The fleet management web portal may enable manufacturers, operators, and service providers to coordinate maintenance, repairs, and/or upgrades of the machines or the equipment.

The manufacturers, operators, and service providers may access the management solution portal or fleet management web portal that may include an application that is executable on computer hardware, such as a microprocessor, or may be an application that is executable over one or more of a local-area network, a wide-area network, a cloud-based network, etc. In one aspect, the fleet management web portal may be a part of a website or web application.

In one aspect, the fleet management web portal may be accessed with an electronic device, such as but not limited to, a desktop computer, a laptop, a tablet, a mobile phone, etc. The electronic device may establish a wired or wireless connection on a communication channel with at least one server hosting an interface and/or a database associated with the fleet management web portal. The electronic device may include at least a display screen and at least one input device. In one aspect, the at least one input device may include one or more of a keyboard, a mouse, a button, a touchpad, a touchscreen, or the like. In one aspect, the display screen and the at least one input device may be a touch-screen display to display images and to receive inputs and gestures performed on a surface of the display screen.

In one aspect, the home screen page 100 may include a first row of selection links or tabs 110 associated with primary sections of the management solution portal or a fleet management web portal. In one aspect, the home screen page 100 may include a first panel 120, a second panel 130, and a third panel 140. The first panel 120 may be used to display summary alerts and/or equipment operating parameters. The second panel 130 may be used to display a map, which may contain equipment information relating to the summary alerts and/or equipment operating parameters. The third panel 140 may be used to display a list of alert types and a numerical count for each alert type that is active. In one aspect, the first panel 120, the second panel 130, and/or the third panel 140 may be vertically oriented such that their respective height is greater than their respective width. In one aspect, the second panel 130 may be larger in size than either the first panel 120 or the third panel 140, or the second panel 130 may be larger in size than both the first panel 120 and the third panel 140 combined. In one aspect, the second panel 130 may be centrally located between the first panel 120 and the third panel 140.

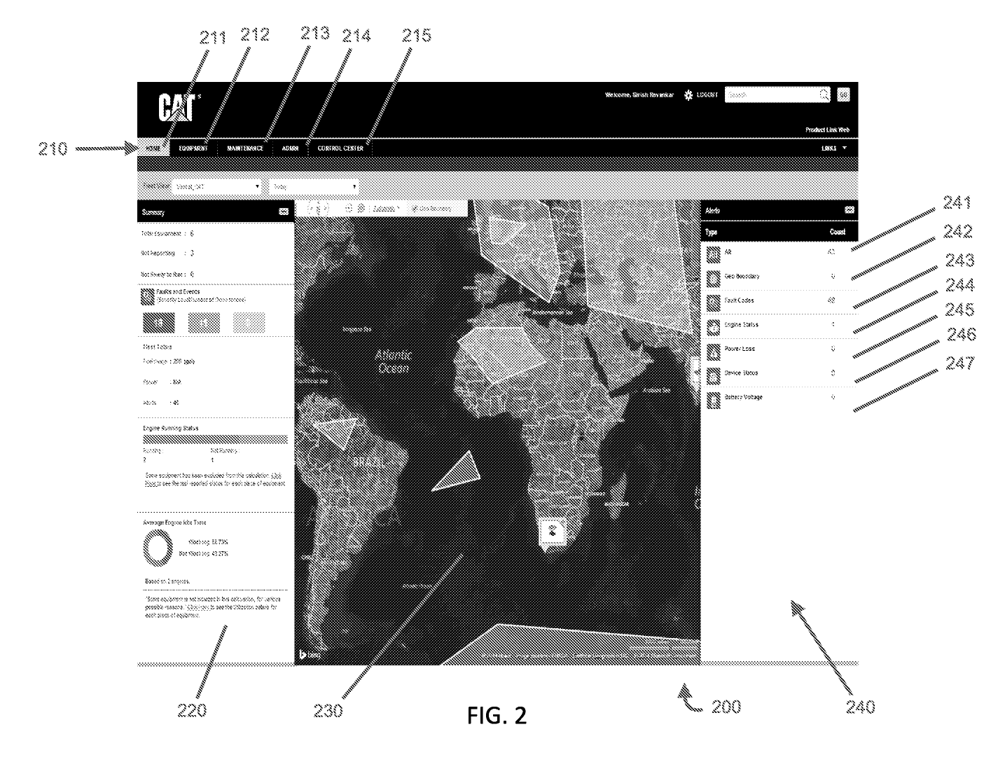

Turning to FIG. 2, a home screen page 200 of the fleet management web portal may be displayed on the display screen and populated with equipment and alert information. The home screen page 200 may include a plurality of selection links or tabs 210, a first side panel 220, a main panel 230, and a second side panel 240. In one aspect, the main panel 230 may display equipment information together with geographic information. In one aspect, the equipment information may be displayed on a map. In one aspect, the map may be adjusted to zoom in or zoom out of a current view, or scrolled in any direction to reveal additional map information that may not be present on a current view of the main panel 230. In one aspect, the plurality of selection links or tabs 210 may include one or more of a home tab 211, an equipment tab 212, a maintenance tab 213, an admin tab 214, and a control center tab 215. In one aspect, the plurality of selection links or tabs 210 may display along a top portion of the home screen page 200.

In one aspect the first side panel 220 may display summary information relating to a fleet of equipment. In one aspect, the second side panel 240 may display alert information relating to the fleet of equipment. The second side panel 240 may display a numerical count of alerts. The numerical count of alerts displayed within the second side panel 240 may be divided into alert subcategories, which may include one or more of the following subcategories: all 241, geographic boundary 242, fault codes 243, engine status 244, power loss 245, device status 246, and battery voltage 247.

In one aspect, each of the alert subcategories 241, 242, 243, 244, 245, 246, 247 of the second side panel 240 may be selectable to display additional equipment alert information relating to that subcategory. For example, the fault codes 243 alert subcategory, as shown in FIG. 2, may be selected from the second side panel 240. By clicking on or selecting one of the alert subcategories 241, 242, 243, 244, 245, 246, 247, the second side panel 240 may be updated to show equipment associated with the alert count for that respective subcategory. In one aspect, the second side panel 240 may be updated and refreshed when one of the alert subcategories 241, 242, 243, 244, 245, 246, 247 is selected, while information displayed on the first side panel 220 and/or the main panel 230 remains the same.

In one aspect, by selecting the fault codes 243 alert subcategory as shown in FIG. 2, at least a portion of the second side panel 240 may be updated and/or refreshed to show equipment having fault codes alerts.

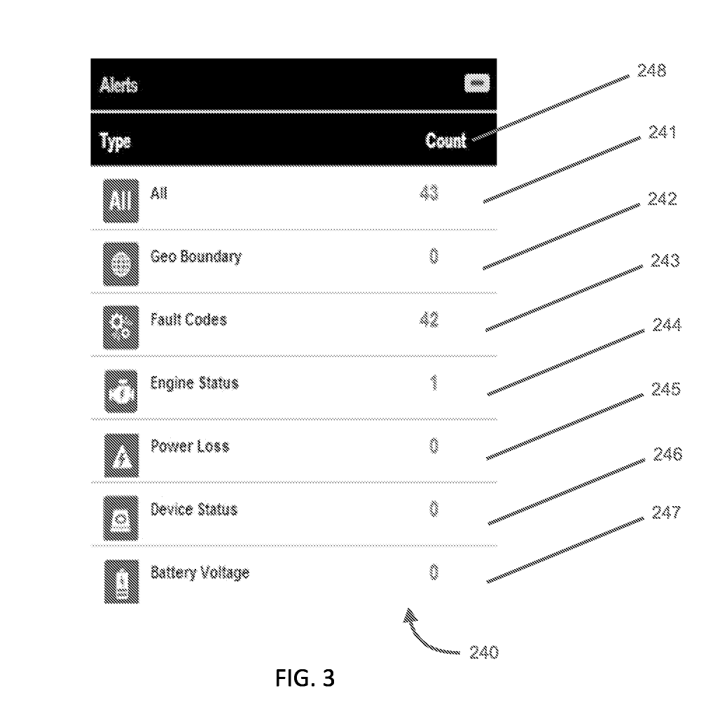

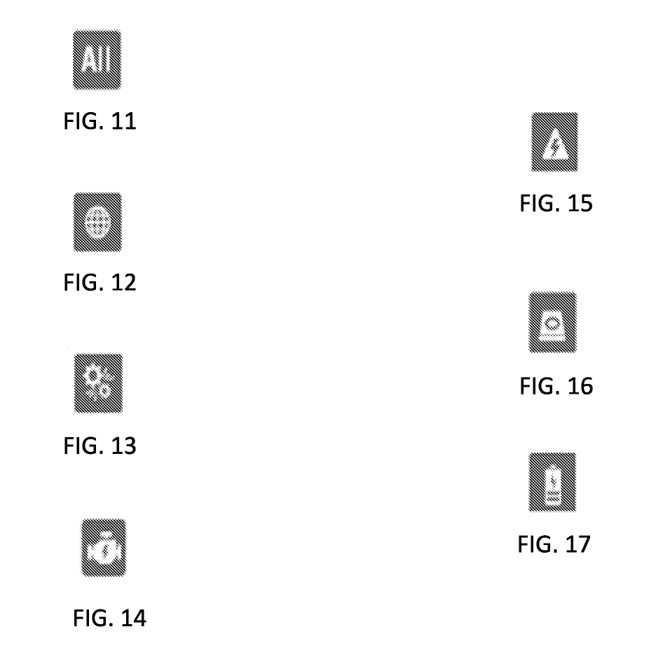

As shown in FIGS. 3-17, the second side panel 240 may include icons, or both icons and text associated with each of the alert subcategories 241, 242, 243, 244, 245, 246, 247. The icons and/or text may help a user readily identify a type of alert which may be active. In one aspect, the second side panel 240 may include a count column 248 to display a present count of the alerts that is presently active or being reported. In one aspect, a size of the icons and/or associated text may be selected to improve readability and enhance presentation of alert information. In one aspect, the icons of FIGS. 11-17 may have a height of between 60 to 70 pixels, and a width of between 40 to 50 pixels. In select aspects, a height of the icon may be 65 pixels, and a width of the icon may be 43 pixels.

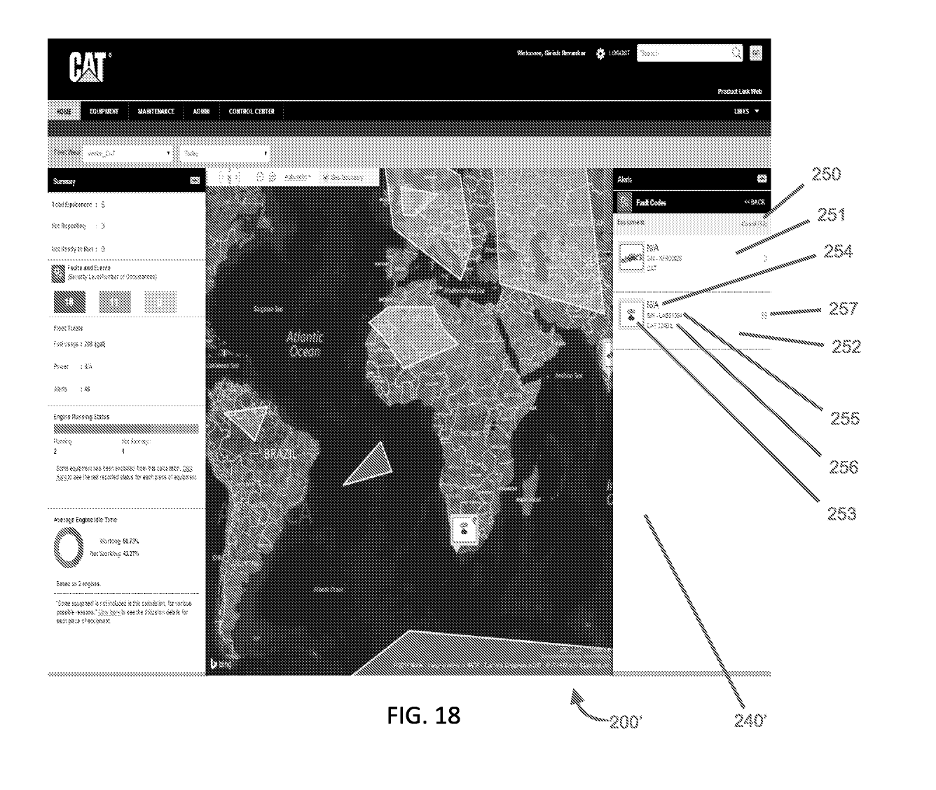

The fault codes subcategory 243 may be selected from the second side panel 240, and the second side panel 240 may be updated to show equipment information relating to fault codes alerts, as shown in FIG. 18. Upon selection of the fault codes subcategory 243, the updated second side panel 240′ may display a numerical count 250, representing a total number of active and/or reported alerts for that alert type. In one aspect, a list of equipment may be displayed below the numerical count 250, and each piece of equipment 251, 252 may be identified by one or more of an icon 253, a name 254, a serial number 255, or a product number 256. In one aspect, a count 257 may be associated with the piece of equipment 252 to indicate a number of active and/or reported alerts associated with that piece of equipment 252. Each piece of equipment 251, 252 listed in the second side panel 240′ may be selectable to display additional information relating to that specific piece of equipment, as will be discussed in further detail below.

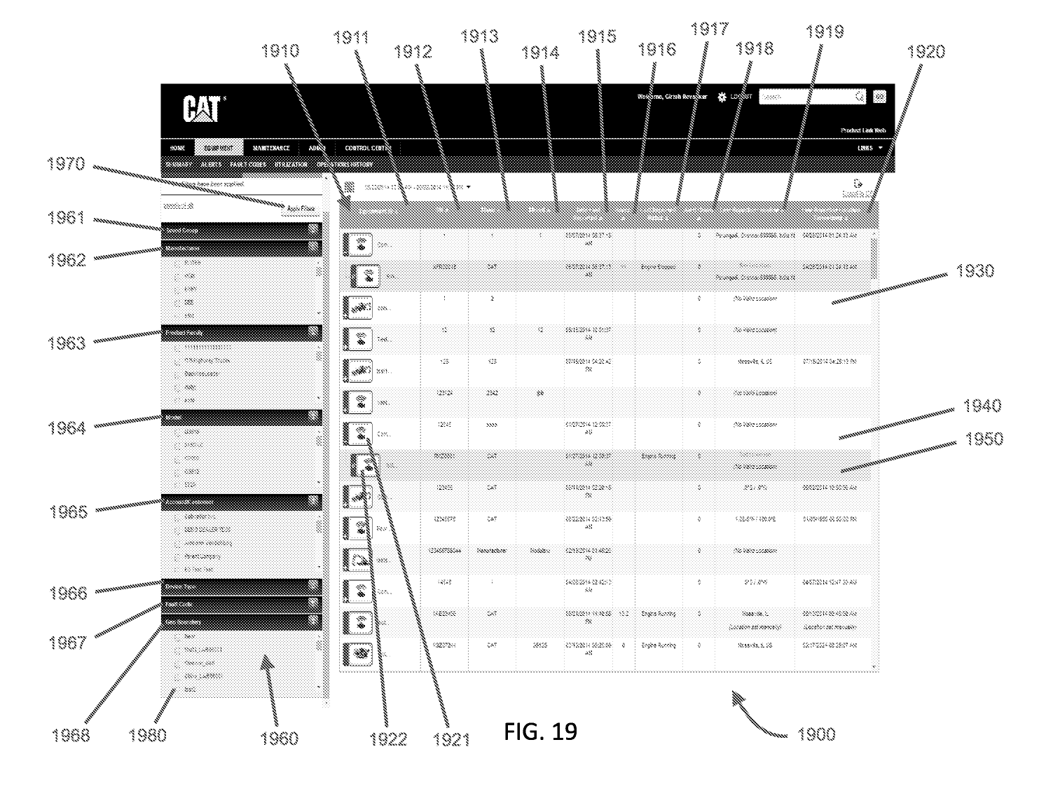

Turning to FIG. 19, an equipment summary page 1900 may be accessed by selecting the equipment tab 212 from the plurality of selection links or tabs 210. The equipment summary page 1900 may include a header 1910 for organizing and arranging a list, chart, or grid of equipment. The header 1910 may be in the form of a row and may include one or more of the following categories: equipment identification 1911, serial number 1912, equipment make 1913, equipment model 1914, date of last report 1915, hours 1916, last reported status 1917, alert count 1918, last reported location 1919, and last reported location time stamp 1920. In one aspect, each of the categories may be used to sort numeric, alphanumeric, and or textual information. In one aspect, the equipment identification 1911 may be used to sort types of equipment, and the types of equipment may be shown with an icon 1921. In one aspect, certain equipment may be linked to or associated with sub-equipment identified by a sub-icon 1922. In one aspect, information associated with each piece of equipment, or sub-equipment, may be listed horizontally to increase the number of equipment entries that may be displayed on the equipment summary page. In one aspect, a height associated with each row 1930 of equipment may be sized to fit the icon 1920, sub-icon 1922, or a corresponding number of rows of text. In one aspect, the corresponding number of rows of text is three to four lines. In one aspect, the height of the row 1930 may be between 50 to 70 pixels. In select aspects, the height of the row 1930 may be 60 pixels.

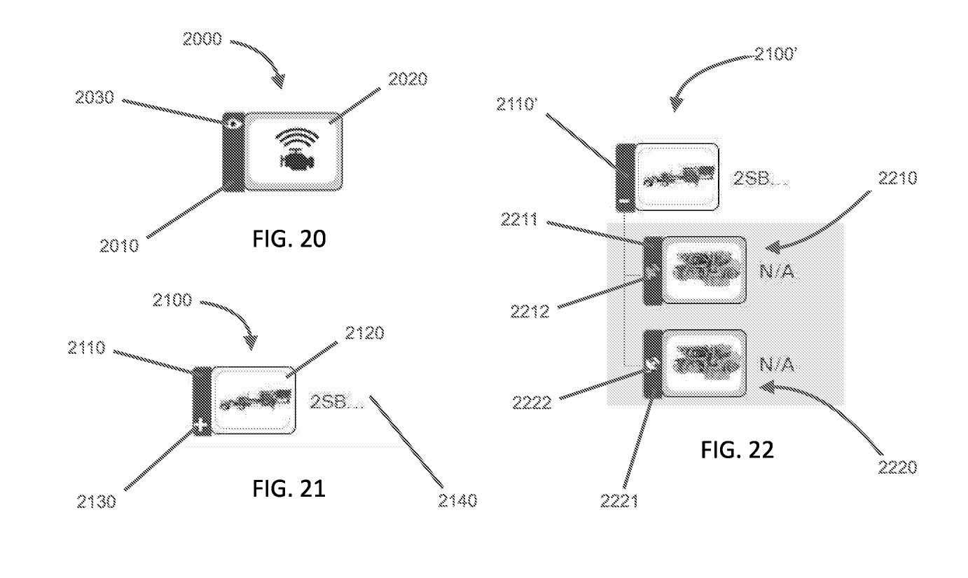

Referring to FIG. 20, a first exemplary icon 2000 may be used to depict a piece of equipment. The icon 2000 may include a sidebar 2010 and a graphical image 2020. The sidebar 2010 may include an indicator 2030 to convey additional information. In one aspect, the indicator 2030 may be a graphical image of an eye, and may be used to represent that the piece of equipment is assigned to one or more viewers.

Referring to FIG. 21, a second exemplary icon 2100 may be used to depict a piece of equipment, the icon 2100 may include a sidebar 2110, a graphical image 2120, and an indicator 2130 in the sidebar 2110. In one aspect, the icon 2100 may be displayed next to text 2140, which may provide a name, type, or description associated with the piece of equipment. In one aspect, the indicator 2130 may be a graphical image of a plus sign (“+”), and may be used to indicate that the piece of equipment is linked to or associated with sub-equipment. Referring to FIG. 22, the sidebar 2110 or the indicator 2130 may be selected to reveal sub-icons 2210, 2220 of the associated sub-equipment. Once the sidebar 2110 and/or the indicator 2130 has been selected, the sidebar 2110′ of the icon 2100 may be updated with a graphical image of a minus sign (“−”), and may be used to indicate that associated sub-equipment information and sub-icons 2210, 2220 may be minimized or hidden. In one aspect, the sub-icons 2210, 2220 may be indented or offset with respect to the icon 2100 in a horizontal direction. Other graphical images/symbols and orientations of the sub-icons 2210, 2220 relative to the icon 2100 are contemplated.

The sub-icons 2210, 2220 may each include respective sidebars 2211, 2221. The sidebars 2211, 2221 may include an indicator 2212, 2213. In one aspect, the indicators 2212, 2222 may be a graphical image of a satellite dish, and may be used to indicate that an associated piece of equipment has data transmission capabilities and/or global positioning system capabilities. In one aspect, the indicator 2212 may be darkened or tinted in comparison with the indicator 2222, and may be used to indicate that the associated piece of equipment has data transmission capabilities and/or global positioning system capabilities, but that those capabilities have not been activated, have been disabled, or is serving as backup to another piece of equipment that has data transmission capabilities and/or global positioning system capabilities activated.

Referring back to FIG. 19, if an icon in a first row 1940 with a plus sign indicator is selected, the icon 1921 may then be updated with a minus sign indicator and associated pieces of sub-equipment, represented by sub-icon 1922, may be populated directly below in a subsequent row 1950. The list of equipment and/or sub-equipment may be sorted in ascending or descending order by selecting a respective category of the header 1910. In one aspect, each icon may have a height and/or width of approximately three to four lines of text displayed in the list of equipment in order to provide an icon that is easily identifiable to a user and allows the list to accommodate more assets.

The equipment summary page 1900 may include a filter panel 1960, which may include one or more selections for filtering down or narrowing the list of equipment to be displayed on the equipment summary page 1900. In one aspect, the filter panel 1960 may be provided adjacent to the list of equipment. In one aspect, the filter panel 1960 may include an apply filter button 1970, which may be used to execute a filtering process and update a list of equipment to be displayed on the equipment summary page 1900. In one aspect, the filter panel 1960 may include filter categories, which may include one or more of saved groups 1961, manufacture 1962, product family 1963, model 1964, account and/or customer 1965, device type 1966, fault code 1967, and geographic boundary (“geo boundary”) 1968. In one aspect, the filter categories may include one or more check boxes 1980 to select or deselect element or elements to filter.

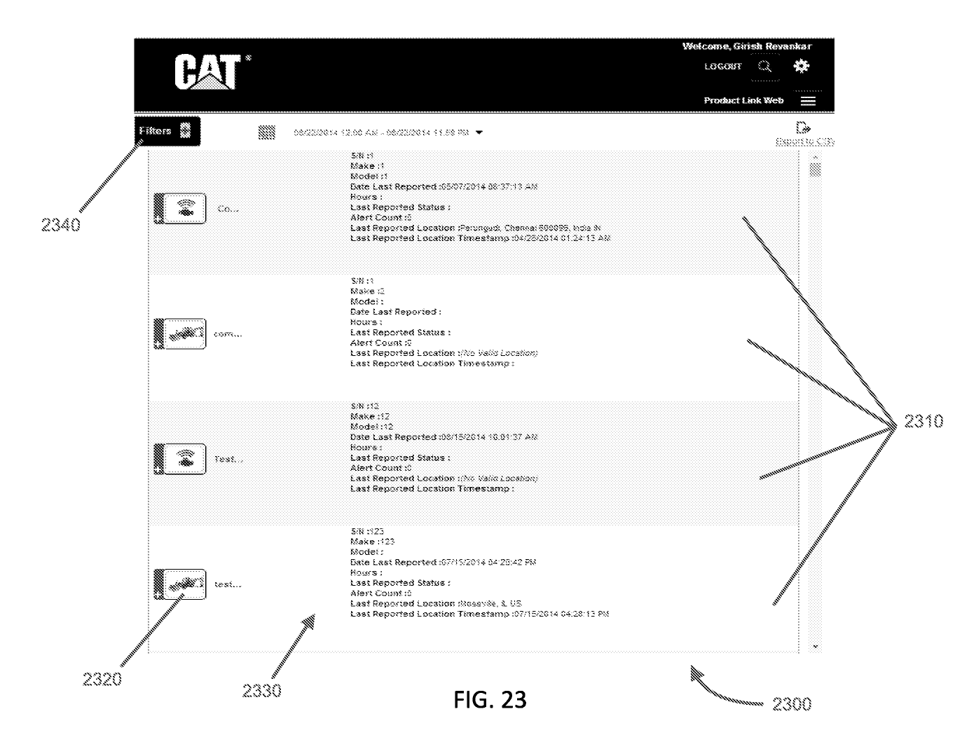

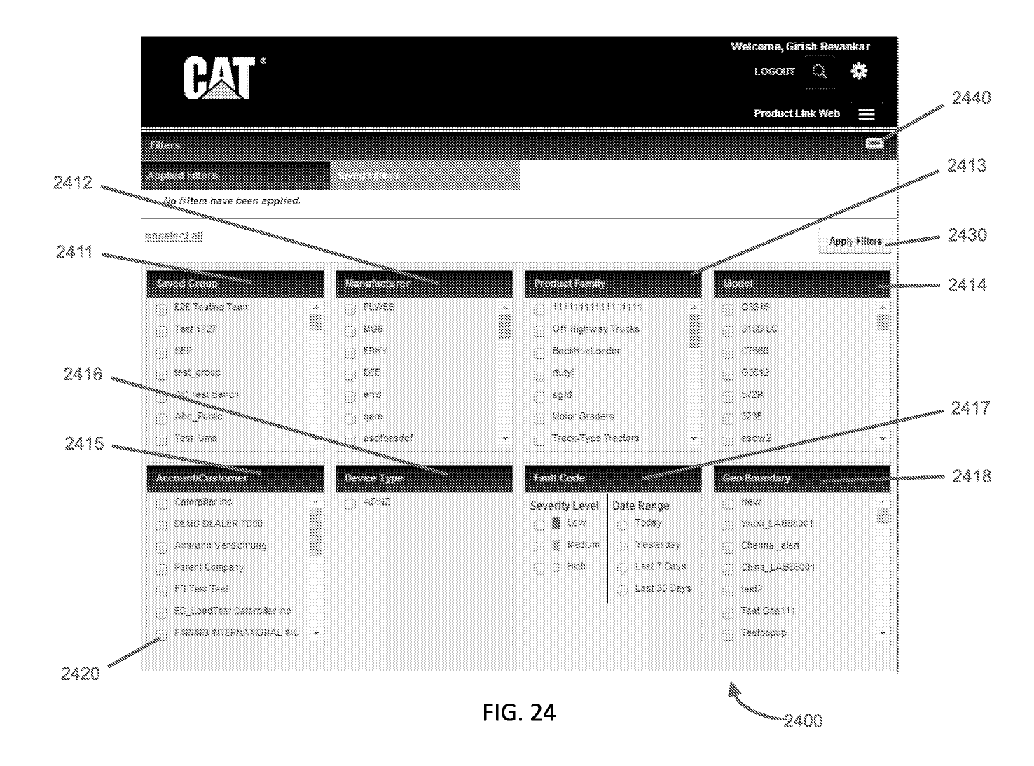

Turning to FIGS. 23 and 24, an alternative equipment summary page 2300 may be provided that is made responsive to adopt screen resolutions for tablets. By providing a tablet layout, the alternative equipment summary page 2300 may be more responsive and may be displayed more clearly on electronic devices such as a tablet, which may have a more limited display screen size than a desktop computer or laptop. In one aspect, the equipment summary page 2300 may display a list of equipment including rows 2310. Each row 2310 may be associated with a piece of equipment and may include an icon 2320, which may operate in a fashion similar to those discussed above. In one aspect, each row 2310 may include equipment details 2330. The equipment details 2330 may include one or more of serial number, make, model, date last reported, hours, last reported, alert count, last reported location, and last reported location timestamp. In one aspect, the icon 2320 and the equipment details 2330 are arranged horizontally with respect to each other. In one aspect the alternative equipment summary page 2300 may be displayed in a landscape orientation.

In one aspect, the alternative equipment summary page 2300 may include a filter button 2340, which may be used to bring up a filter selection page 2400, as shown in FIG. 24. In one aspect, the filter selection page 2400 may include one or more filter categories, which may include one or more of saved groups 2411, manufacture 2412, product family 2413, model 2414, account and/or customer 2415, device type 2416, fault code 2417, and geo boundary 2418. In one aspect, the filter categories may include one or more check boxes 2420 to select or deselect elements to filter. In one aspect, the filter selection page 2400 may include an apply filters button 2430, which may be used to execute a filtering process and to update a list of equipment to be displayed on the alternative equipment summary page 2300. In one aspect, the alternative equipment summary page 2300 and the filter selection page 2400 are not displayed simultaneously to reduce clutter and to enhance responsiveness of the electronic device. In one aspect, the filter selection page 2400 may include a minimize button 2440 for minimizing the filter selection page 2400 and for returning to the alternative equipment summary page 2300.

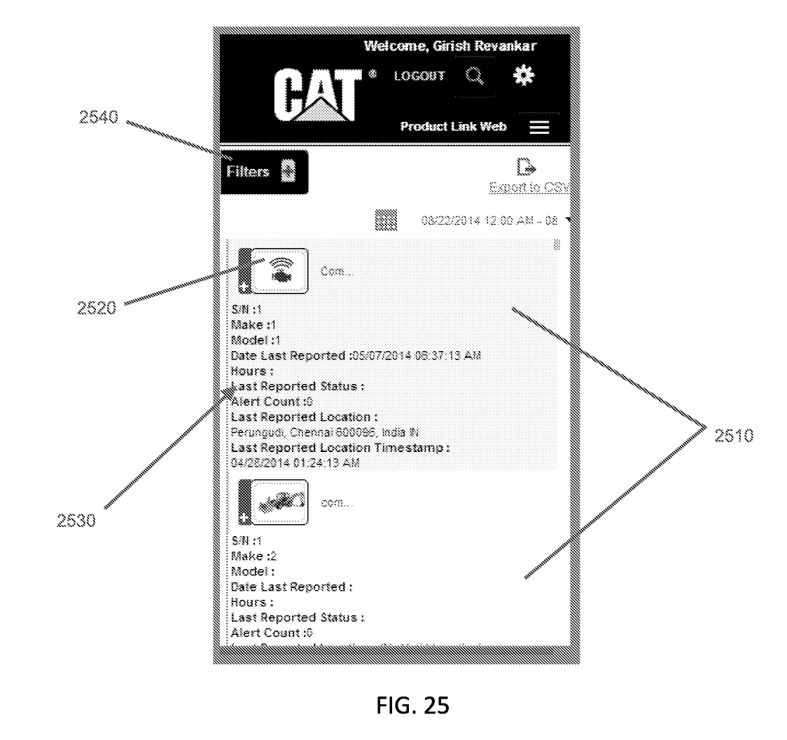

As shown in FIG. 25, a second alternative equipment summary page 2500 may be provided that is made responsive to adopt screen resolutions for mobile devices. In one aspect, the mobile device may be a phone, mobile smartphone as defined herein, or other electronic device with a 7-inch or less display screen size. By providing a mobile device layout, equipment summary page 2500 may be more responsive and may be displayed more clearly on electronic devices such as a mobile phone or a smartphone. In one aspect, the equipment summary page 2500 may display a list of equipment. In one aspect, the list of equipment may include one or more icons associated with each piece of equipment of the list of equipment. In one aspect, the second alternative equipment summary page 2500 may include a list of equipment. In one aspect, the equipment summary page 2500 may display a list of equipment including rows 2310. Each row 2510 may be associated with a piece of equipment and may include an icon 2520, which may operate in a fashion similar to those discussed above. In one aspect, each row 2510 may include equipment details 2530. The equipment details 2330 may include one or more of serial number, make, model, date last reported, hours, last reported, alert count, last reported location, and last reported location timestamp. In one aspect, the icon 2520 and the equipment details 2530 are arranged vertically with respect to each other. In one aspect the second alternative equipment summary page 2500 is displayed in a portrait orientation. In one aspect, the second alternative equipment summary page 2500 may include a filter button 2540, which may be used to bring up a filter selection page having a portrait orientation.

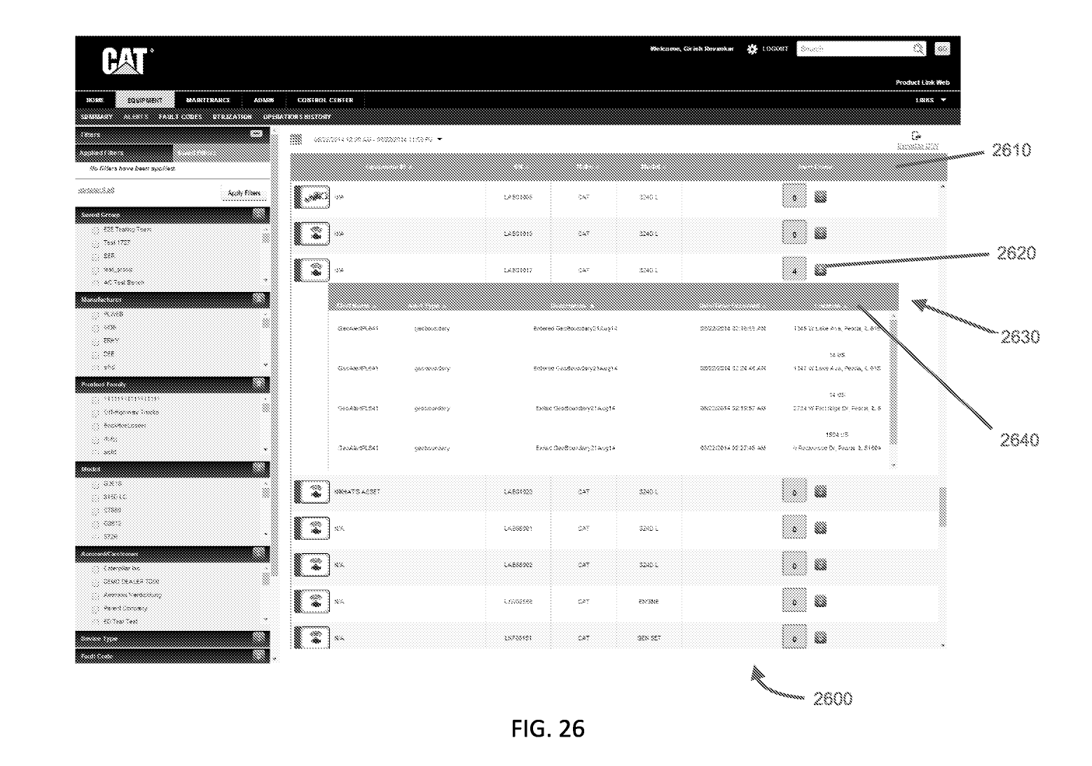

As shown in FIG. 26, an equipment alert page 2600 may display at least a list of equipment and a respective alert count for one or more individual machines. The list of equipment may be sorted in ascending or descending order by selecting a respective column header. In one aspect, the list of equipment may include one or more icons associated with each piece of equipment of the list of equipment. In one aspect, each icon may have a height and/or width of approximately a height of three to four lines of text which is being displayed in the list of equipment, thus providing an icon that is readily identifiable to a user while allowing the list to accommodate more assets. In one aspect, the equipment alert page 2600 may include an alert count column 2610 to display a numerical alert count for each respective piece of equipment.

In one aspect, the alert count column 2610 may include a button 2620 associated with a piece of equipment. If the alert count is greater than zero, the button 2620 may be selected to open a details panel 2630 to provide alert information for that piece of equipment. In one aspect, the details panel 2630 may include a column header 2640 and may include one or more of the following fields: alert names, alert type, description, date/time occurred, and location. Each of the fields may be selectable to sort alerts associated with the piece of equipment.

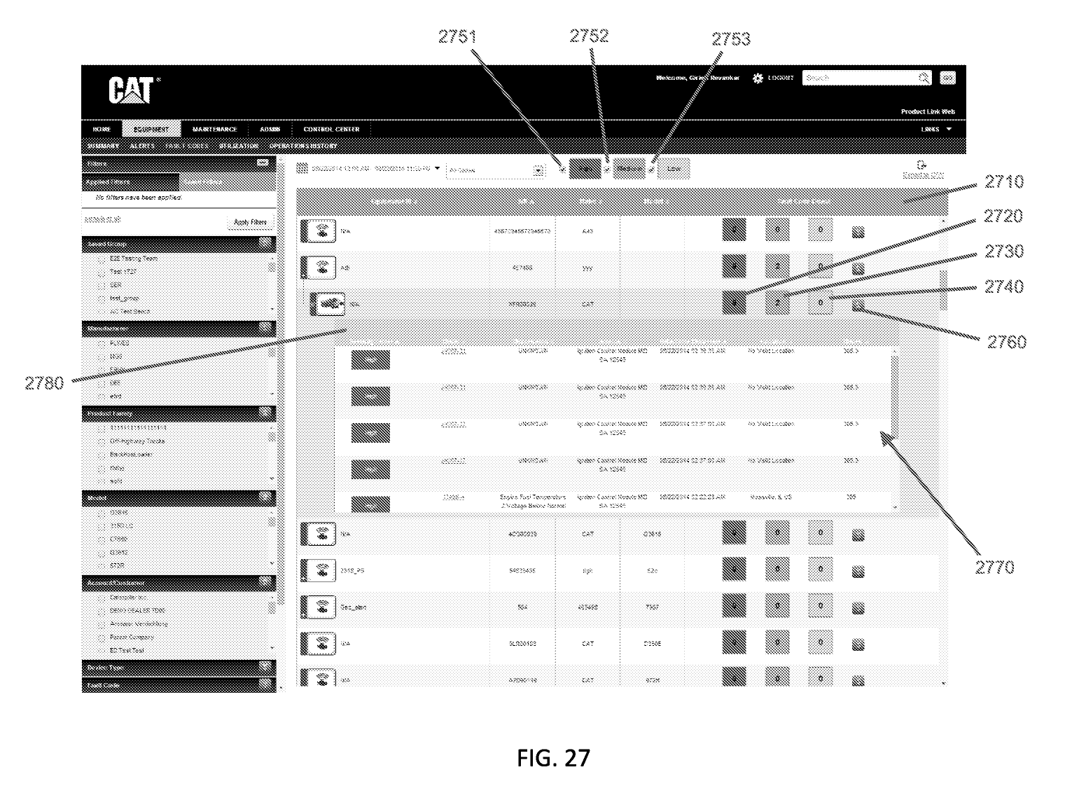

As shown in FIG. 27, an equipment fault codes page 2700 may display at least a list of equipment and a respective fault code for one or more individual machines. The list of equipment may be sorted in ascending or descending order by selecting a respective column header. In one aspect, each icon may have a height and/or width of approximately a height of three to four lines of text which is being displayed in the list of equipment, thus providing an icon that is readily identifiable to a user while allowing the list to accommodate more assets. In one aspect, the equipment fault codes page 2700 may include a fault code count column 2710 to display one or more fault code counters 2720, 2730, 2740 for each respective piece of equipment. In one aspect, the equipment fault codes page 2700 may include a high severity selection check box 2751, a medium severity selection check box 2752, and a low severity selection check box 2753. The check boxes 2751, 2752, 2753 may each be checked in order to display the corresponding fault code counter(s) in the fault code count column 2710. Alternatively, The check boxes 2751, 2752, 2753 may each be unchecked in order to hide the corresponding fault code counter(s) in the fault code count column 2710.

In one aspect, a first fault code counter 2720 may represent a count of the number of high severity fault codes for that particular piece of equipment. In select aspects, the first fault code counter 2720 may include a specific distinguishing color such as a red color. In one aspect, a second fault code counter 2730 may represent a count of the number of medium severity fault codes for that particular piece of equipment. In select aspects, the second fault code counter 2730 may include a specific distinguishing color such as an orange color. In one aspect, a third fault code counter 2740 may represent a count of the number of low severity fault codes for that particular piece of equipment. In select aspects, the third fault code counter 2740 may include a specific distinguishing color such as a yellow color. Other colors are of course contemplated.

In one aspect, the fault code count column 2710 may include a button 2760 associated with a piece of equipment. If the fault code count is greater than zero, in one or more of the displayed severity category, the button 2760 may be selected to open a details panel 2770 to provide additional severity level information for that piece of equipment. In one aspect, the details panel 2770 may include a column header 2780 and may include one or more of the following fields: severity level, code, description, source, date/time, location, and hours. Each of the fields may be selectable to sort alerts associated with the piece of equipment.

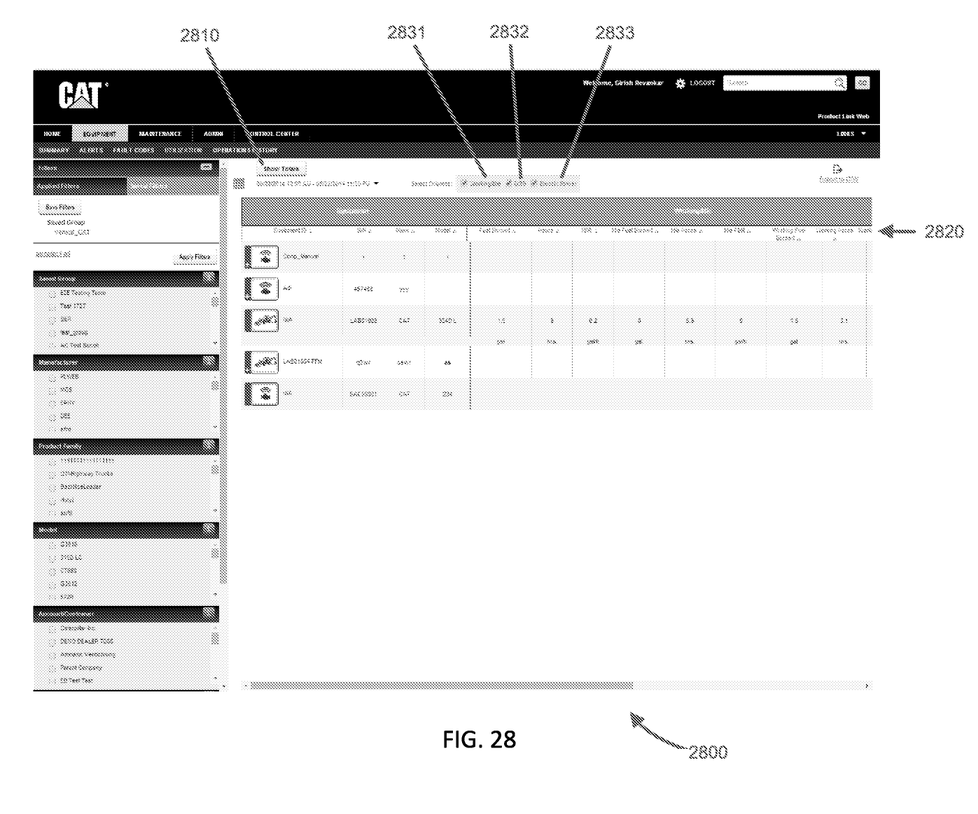

As shown in FIG. 28, an equipment utilization page 2800 may display at least a list of equipment and respective utilization data for one or more individual machines. The list of equipment may be sorted in ascending or descending order by selecting a respective column header. In one aspect, the list of equipment may include one or more icons associated with each piece of equipment of the list of equipment. In one aspect, each icon may have a height and/or width of approximately a height of three to four lines of text which is being displayed in the list of equipment, thus providing an icon that is readily identifiable to a user while allowing the list to accommodate more assets. In one aspect, the equipment utilization page 2800 may include one or more of the following utilization data categories: fuel burned, hours, fuel burn rate, idle fuel burned, idle hours, idle fuel burn rate, working fuel burned, and working hours. In one aspect, the utilization data categories may be provided in a header 2820, and a respective column representing a utilization data category may be selected to sort data in accordance with that utilization data category.

In one aspect, the equipment utilization page 2800 may include a show totals button 2810 which may launch a pop-up screen to display a sum of the data in each of the displayed columns of the equipment utilization page 2800. In one aspect, the equipment utilization page 2800 may include one or more of a working/idle check box 2821, a dynamic gas blending (DGB) check box 2822, and an electric power box 2823. The check boxes 2821, 2822, 2823 may each be checked in order to show a corresponding column, or may each be unchecked to hide a corresponding column.

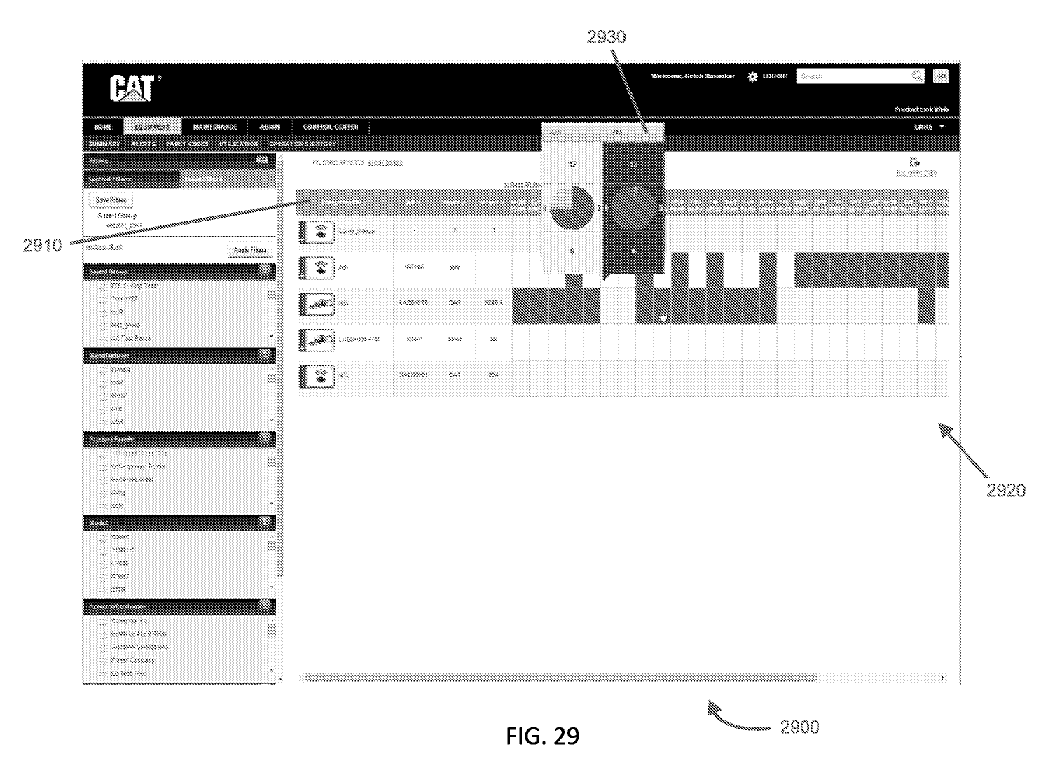

As shown in FIG. 29, an equipment operation page 2900 may display at least a list of equipment and respective operation information for one or more individual machines. The list of equipment may be sorted in ascending or descending order by selecting a respective column header 2910. In one aspect, the list of equipment may include one or more icons associated with each piece of equipment of the list of equipment. In one aspect, each icon may have a height and/or width of approximately a height of three to four lines of text which is being displayed in the list of equipment, thus providing an icon that is readily identifiable to a user while allowing the list to accommodate more assets. In one aspect, the equipment operation page 2900 may display operation data based on dates and/or times of the day. In one aspect, a date grid 2920 may be provided to show equipment operation for a particular day of the week or day of the month. In one aspect, an equipment operation pop-up window 2930 may be displayed to show operation data in greater detail. In one aspect, the equipment operation pop-up window 2930 may be displayed by selecting or clicking on at least a portion of the displayed operating data. In one aspect, the equipment operation pop-up window 2930 may be displayed by hovering over the at least a portion of the displayed operating data using the input device.

In one aspect, each box may represent a 24-hour day. In one aspect a filled-in or color box may be used to indicate that a corresponding piece of equipment has been running or in operation for that day. In one aspect, an empty or greyed-out box may indicate that the corresponding piece of equipment has not been running or in operation for that day. With respect to the operation pop-up window 2930, a filled-in or colored of the circle may indicate an amount of time that the corresponding piece of equipment has been in operation. In one aspect, an equipment operation pop-up window 2930 may include an AM and a PM section for displaying an amount of operation for each 12-hour increment. By providing the date grid 2920 and the pop-up window 2930, a user may be able to quickly ascertain which pieces of equipment have been in operation for particular days, and additionally how long those pieces of equipment have been running for those particular days.

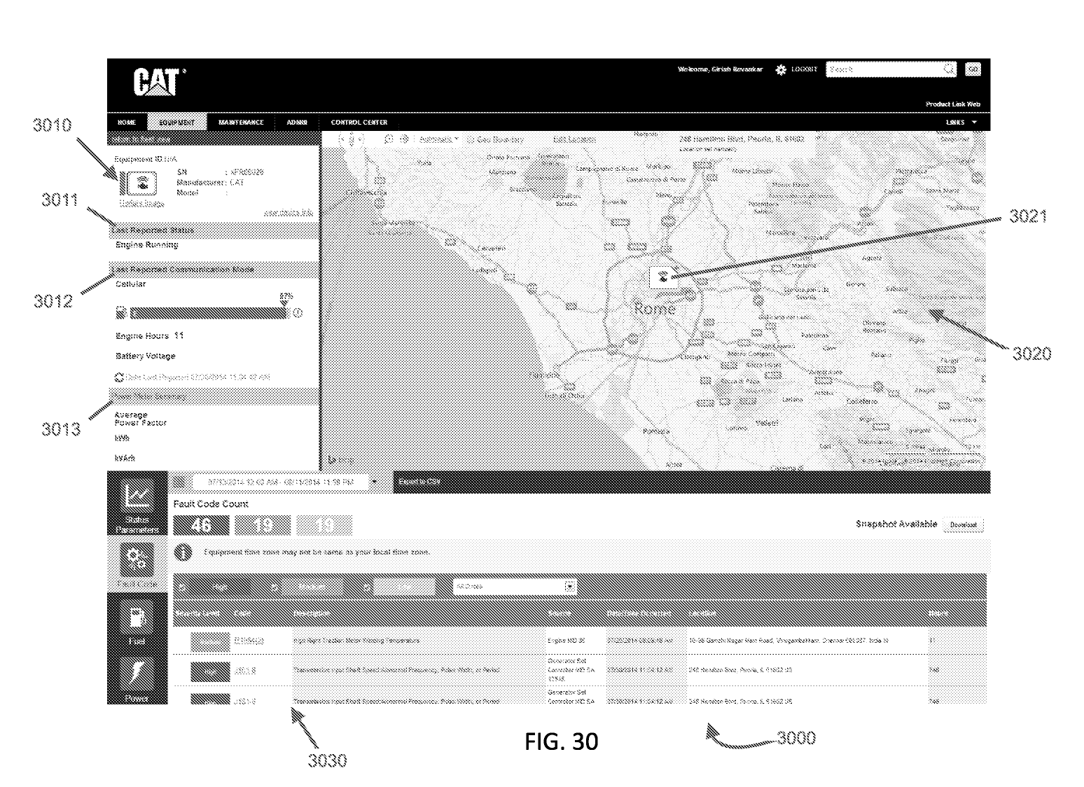

As shown in FIG. 30, an equipment details page 3000 may display equipment details information. The equipment details page 3000 for a particular piece of equipment may be reached by clicking on a respective icon thereof in one or more of the graphical user interfaces discussed above with respect to FIGS. 19, 23, 25, 26, 27, 28, and 29, for example. In one aspect, the equipment details page 3000 may include a first panel 3010, a second panel 3020, and a third panel 3030. In one aspect, the first panel 3010 may display a battery voltage parameter and/or a last reported communication mode. In one aspect, the first panel 3010 may include header bars 3011, 3012, 3013, which may be used to separate different types of equipment information into separate sections. In select aspects, the first header bar 3011 may represent a last reported status, the second header bar 3012 may represent a last reported communication mode, and the third header bar 3013 may represent a power meter summary. Information regarding whether an engine is running may be displayed below the first header bar 3011. Information regarding the last communication mode may include one or more of a type of communication connections, such as cellular or satellite, a fuel gauge, a number of hours an engine has been operated, and a battery voltage may be displayed below the second header bar 3012. Information regarding an average power factor may be displayed below the third header bar 3013. Other types of information relating to the equipment to be displayed in the first panel 3010 are also contemplated. In one aspect, if information relating to one of more of the first header bar 3011, second header bar 3012, and third header bar 3013 are not relevant to the present equipment, that respective header bar may be hidden and not displayed in the first panel 3010.

In one aspect, the second panel 3020 may display a map and/or geographic information. In one aspect, a location of the equipment may be depicted as an icon, a logo, or a symbol 3021 in the second panel 3020. In one aspect, the third panel 3030 may display a status report, which may include one or more of parameter information, fault code information, fuel information, and power information.

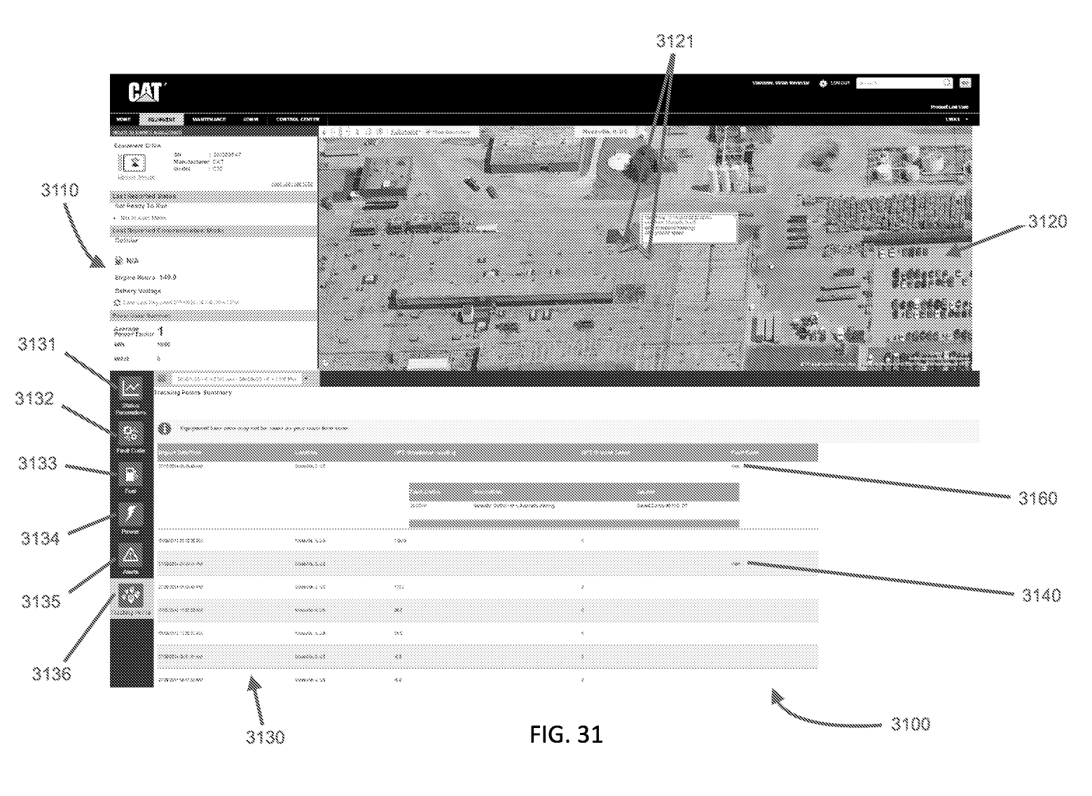

As shown in FIG. 31, an equipment details page 3100, including tracking points, may display equipment details information. In one aspect, the equipment details page 3100 may include a first panel 3110, a second panel 3120, and a third panel 3130. In one aspect, the first panel 3110 may display a battery voltage parameter and/or a last reported communication mode. In one aspect, the second panel 3120 may display a map and/or geographic information. In one aspect, the third panel 3130 may include selectable tabs, which may include one or more of a status parameters tab 3131, a fault codes tab 3132, a fuel tab 3133, a power tab 3134, an alerts tab 3135, and a tracking points tab 3136. In one aspect, when the tracking points tab 3136 is selected, the third panel 3130 may display in a table 3137 tracking points information associated with the selected equipment. Symbols or markers 3121 associated with the tracking points may be displayed in the second panel 3120. In one aspect, selecting a symbol or marker 3121 in the second panel 3120 may cause a corresponding tracking point entry in the table 3137 to be highlighted. Additionally, or alternatively, selecting a tracking point entry in the table 3137 may cause a corresponding tracking point symbol or marker 3121 to be highlighted.

In one aspect, fault codes associated with a track point may be listed in the table 3137. In select aspects, the fault codes associated with a track point are only listed in the table 3137. In one aspect, a view link 3140 may be listed with a track point and may be used to indicate presence of fault code information. The view link 3140 may be selected to display or maximize a fault code details section 3150. In one aspect, when the fault code details section 3150 is displayed or maximized, a hide link 3160 may be associated with a track point and may be selected to close or minimize the fault code details section 3150.

In one aspect, the map in the second panel 3120 may display track points in one or more colors. In one aspect, track points associated with a start may be displayed in a specific distinguishing color such as green, track points associated with a stop may be displayed in red, track points associated with a fault code may be displayed in a specific distinguishing color such as orange, and/or track points associated with other attributes may be displayed in a specific distinguishing color such as blue. Other colors are of course contemplated.

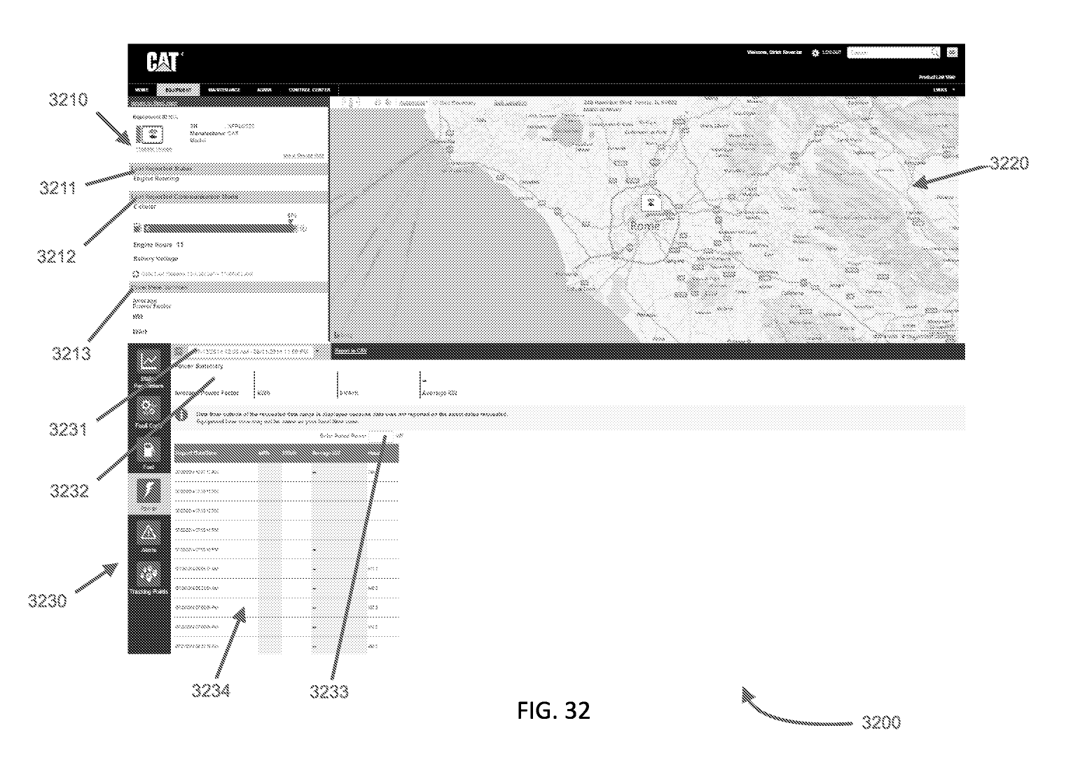

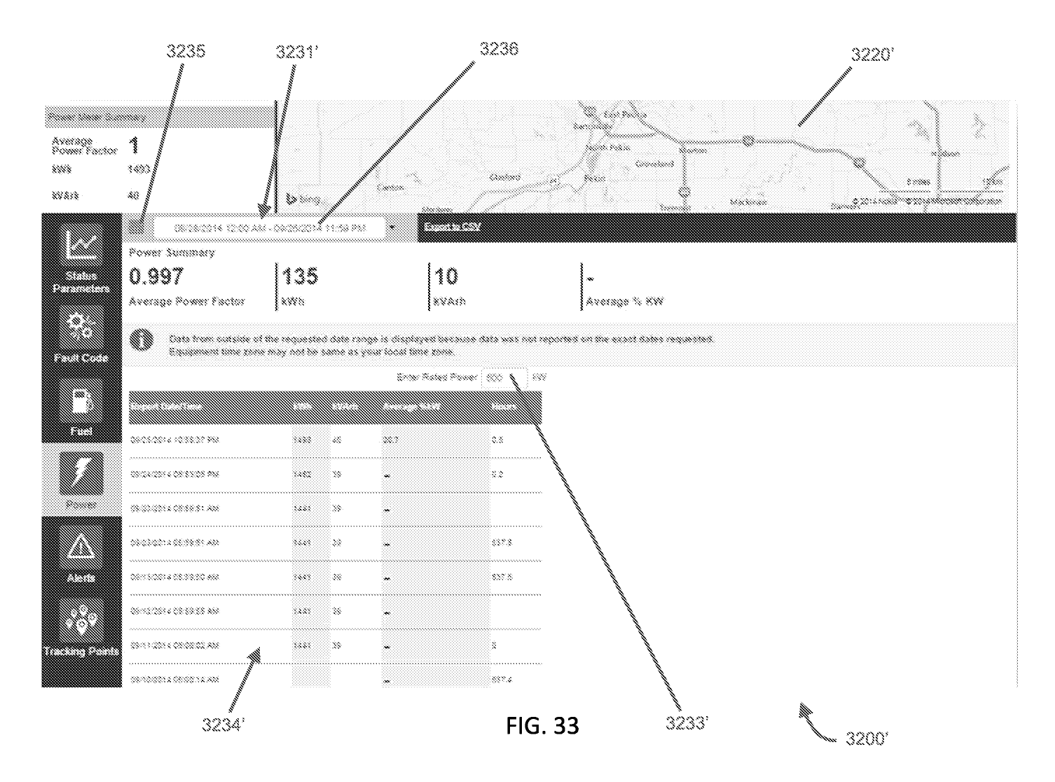

As shown in FIGS. 32 and 33, an equipment details page 3200, including load percent utilization, may display equipment details information. In one aspect, the equipment details page 3200 may include a first panel 3210, a second panel 3220, and a third panel 3230. In one aspect, the first panel 3210 may display one or more of a last reported status 3211, last reported communication mode 3212, and power meter summary 3213. In one aspect, the power meter summary 3213 may be used to display life time power meter values associated with the selected equipment. In one aspect, the second panel 3220 may display a map and/or geographic information. In one aspect, the third panel 3230 may provide power summary information for the selected equipment. In one aspect, the third panel 3230 may include one or more of a date selection tool 3231, a power summary output 3232, a rated power input box 3233, and a chart of reported power values 3234.

As shown in FIG. 33, a date selection tool 3231′ may include a calendar icon 3235 and/or a calendar drop down menu 3236. In one aspect, the calendar icon 3235 may be selected to display a graphical calendar to select a start and end date. In one aspect, the calendar drop down menu 3236 may be selected to reveal a drop down list of pre-populated date ranges. In one aspect, a rated power input box 3233′ may be used to enter a power input rating corresponding to the selected equipment. In one aspect, the rated power input box 3233′ may allow a numerical input and may be in terms of kilowatts (kW). Once a date range and a power input rating has been selected, power summary information of the equipment may be displayed in power summary output 3232′. The power summary output 3232′ may display one or more of an average power factor, kilowatt hours (kWh), kilovolt amps reactive hours (kVArh), and average kilowatts (KW). In one aspect, the equipment details page 3200 may retrieve power report information for the selected period based on parameters selected using the date selection tool 3231′ and may display the information in a chart of reported power values 3234′. In one aspect, the chart of reported power values 3234′ may include a reported date/time, kilowatt hours (kWh), kilovolt amps reactive hours (kVArh), and hours of operation.

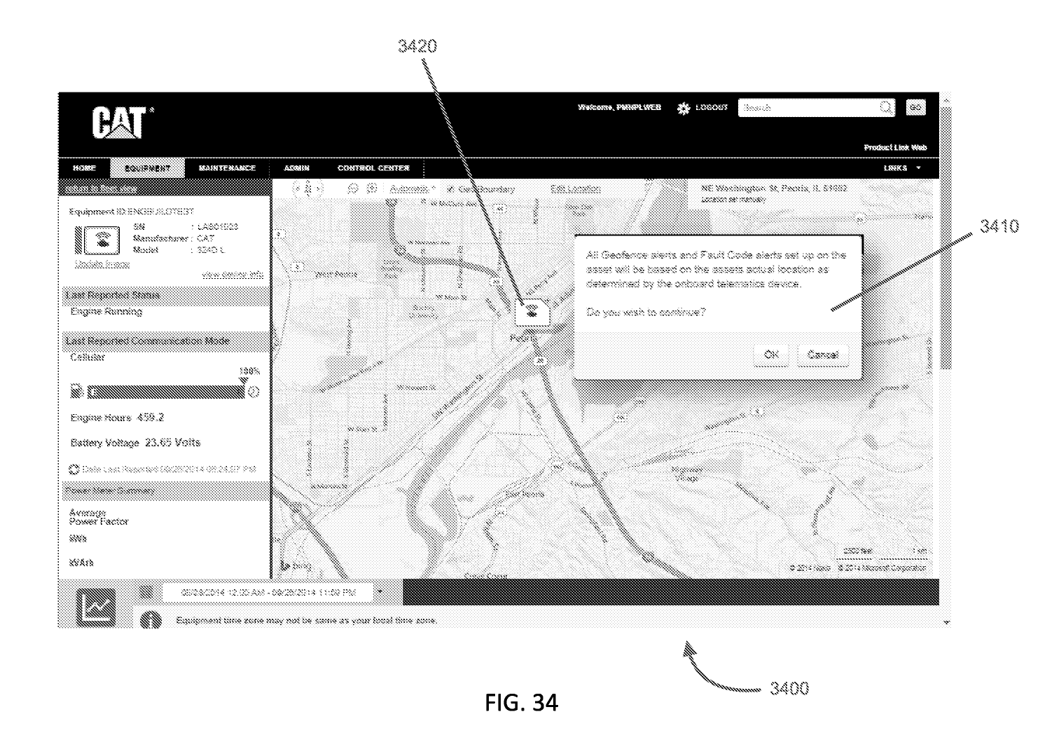

Referring to FIG. 34, a user interface for an equipment details page 3400 including an equipment location dialog 3410 is shown. As discussed above, with reference to FIGS. 30-33, a second panel 3020, 3120, 3220 may be used to display a map or geographic information, and information associated with the equipment may be displayed on the map or other geographic information. In one aspect, an icon 3420 of the equipment may be selected and a location of the equipment may be manually supplied. For example, the location may be manually supplied where the equipment is not equipped with a location sensor, such as a global positioning sensor (GPS). When the icon 3420 is selected, an option for editing a location of the equipment may be presented and may prompt the equipment location dialog 3410 to appear. The equipment location dialog 3410 may be used to confirm whether a user wishes to proceed and may allow the user to input a location of the equipment, which may be in the form of latitudinal and longitudinal coordinates.

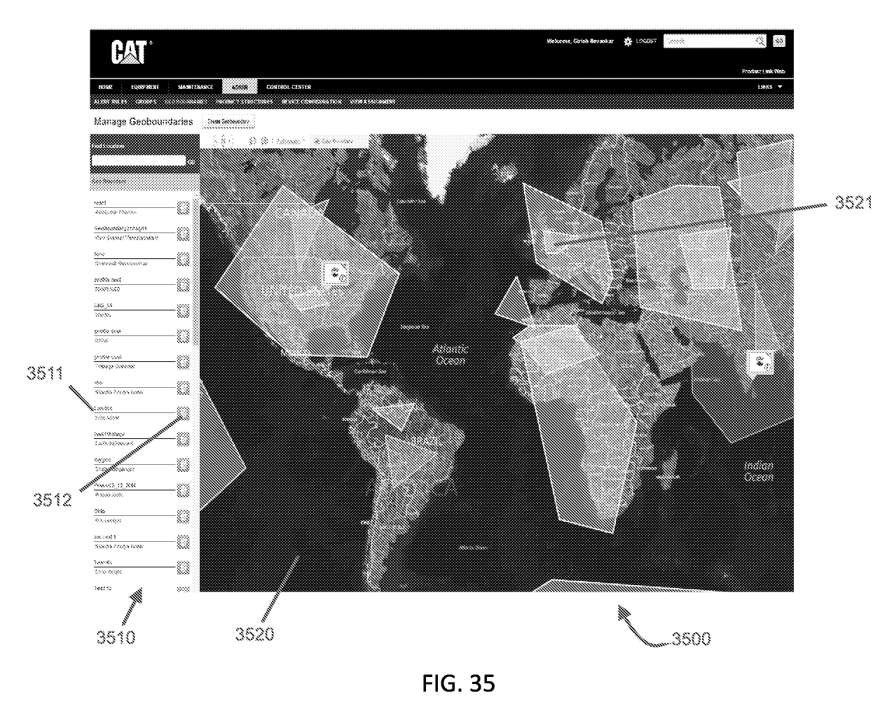

Referring to FIG. 35, a geographic boundary page 3500 may display geo boundary information. In one aspect, the geographic boundary page 3500 may include a first panel 3510 and a second panel 3520. The first panel 3510 and the second panel 3520 may include a same height. In one aspect, the second panel 3520 may be larger than the first panel 3510. In one aspect the geographic boundary page 3500 may include a map that occupies the entire page, or substantially the entire page to improve visibility and usability. In one aspect, the first panel 3510 may include at least one predefined geo boundary 3511. When the geo boundary 3511 is selected, a visual representation of the boundary 3521 may appear in the second panel 3520. When the geo boundary 3511 is deselected, the boundary 3521 may be hidden in the second panel 3520. The geo boundary 3511 may include a trash button 3512 to delete the geo boundary 3511 from the list of geo boundaries that may be displayed in the first panel 3510.

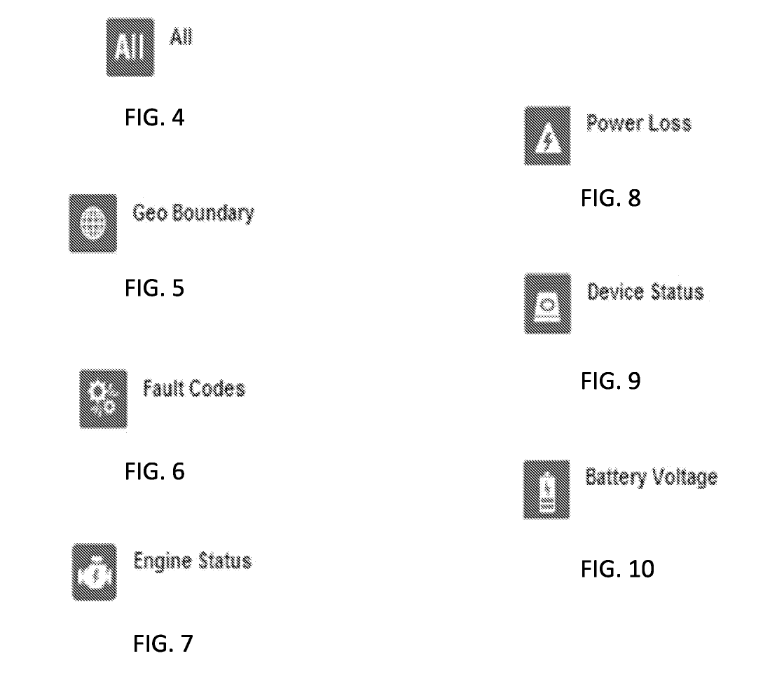

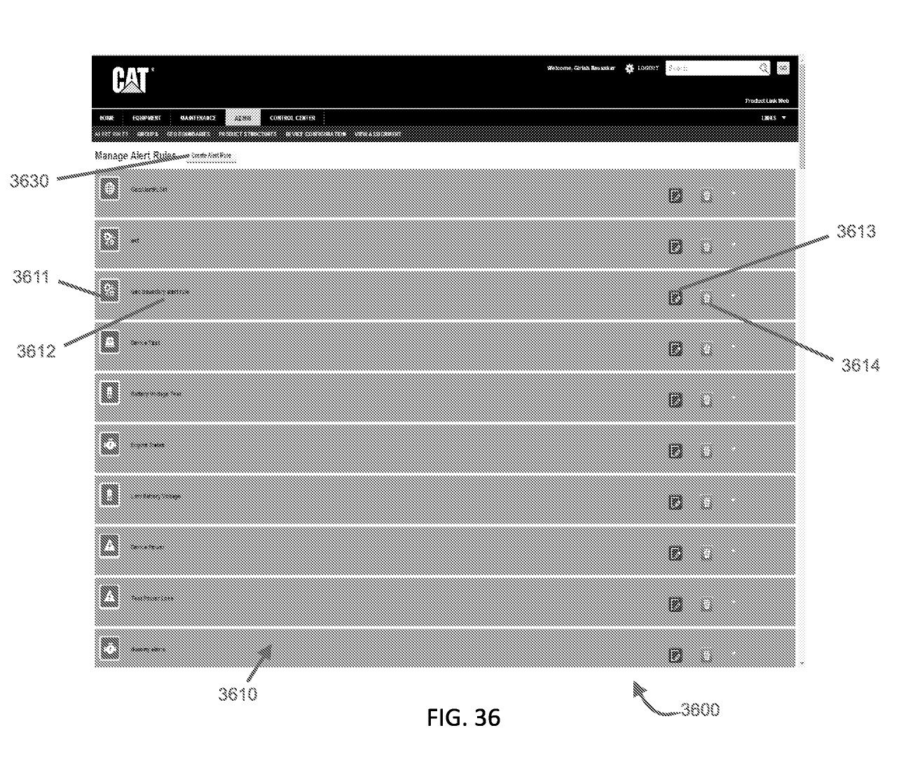

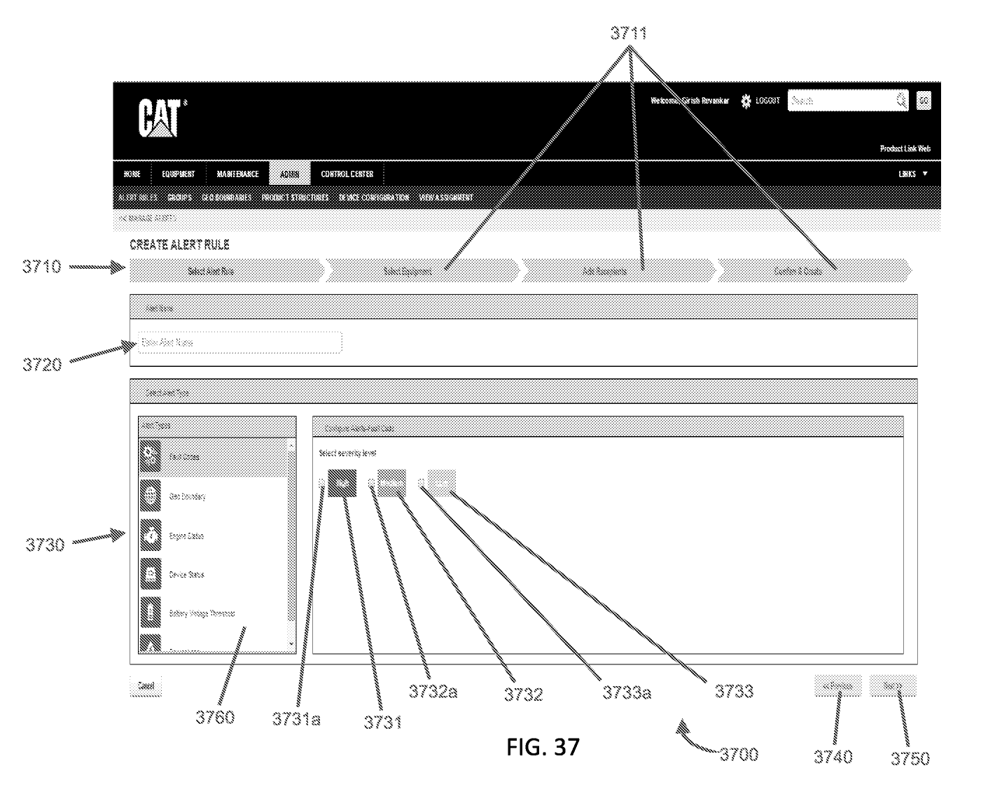

As shown in FIG. 36, a manage alert rules page 3600 may display alert rules options. In one aspect, the manage alert rules page 3600 may display a list of alert rules 3610. Each rule in the list of alert rules 3610 may include one or more of an icon 3611 and a name or description 3612 of the rule. Each rule may further include an edit button 3613 to execute an editing operation and/or a delete button 3614 to delete the rule. In one aspect, the manage alert rules page 3600 may include a create alert rule button 3630 to add additional rules, which may be displayed on the list of alert rules 3610. The create alert rule button 3630, when selected, may direct a user to a create alert rule page 3700 of FIG. 37, as will be discussed in detail below. In one aspect, the icon 3611 of the rule may be selected from one or more of the icons discussed and shown with respect to FIGS. 4-17. Other icons for the rules are of course contemplated.

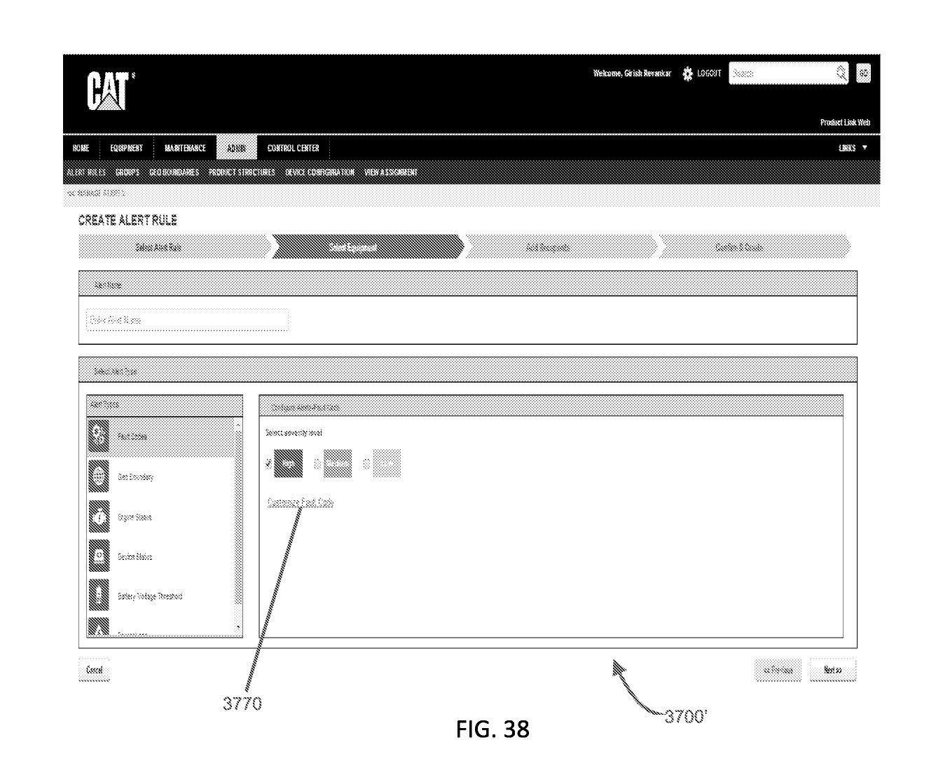

As shown in FIGS. 37 and 38, a create alert rule page 3700 may allow a user to create an alert rule using a wizard style interface. As shown in FIG. 37, the create alert rule page 3700 may include at least a wizard header progress bar 3710, an alert name panel 3720, an alert type panel 3730, a previous button 3740, and a next button 3750. In one aspect, referring to FIG. 38, all required criteria for a respective alert must be met before a next or subsequent tab or tabs 3711 of the wizard header tabs 3710′ is activated or selectable to advance to a next process or page of the alert creation, which may be represented by a next or subsequent tab or tabs 3711. In one aspect, all required criteria for a respective alert must be met before the next button 3740′ is selectable, on the create alert rule page 3700′, to advance to a next process or page of the alert creation. In one aspect, the alert type panel 3730 may include a list of selectable alert types 3760, which may be selected to be associated with a current alert rule. The list of selectable alert types 3760 may include one or more of fault codes, geo boundary, engine status, device status, battery voltage threshold, and power loss. In one aspect, the alert type panel 3730 may include one or more severity selections 3731, 3732, 3733, and each of the severity selections may include a check box or toggle 3731a, 3732a, 3733a. In one aspect, if one or more of the check boxes or toggles 3731a, 3732a, 3733a are selected, a customization of fault mode option 3770, as shown in FIG. 38, may appear in the alert type panel 3730′.

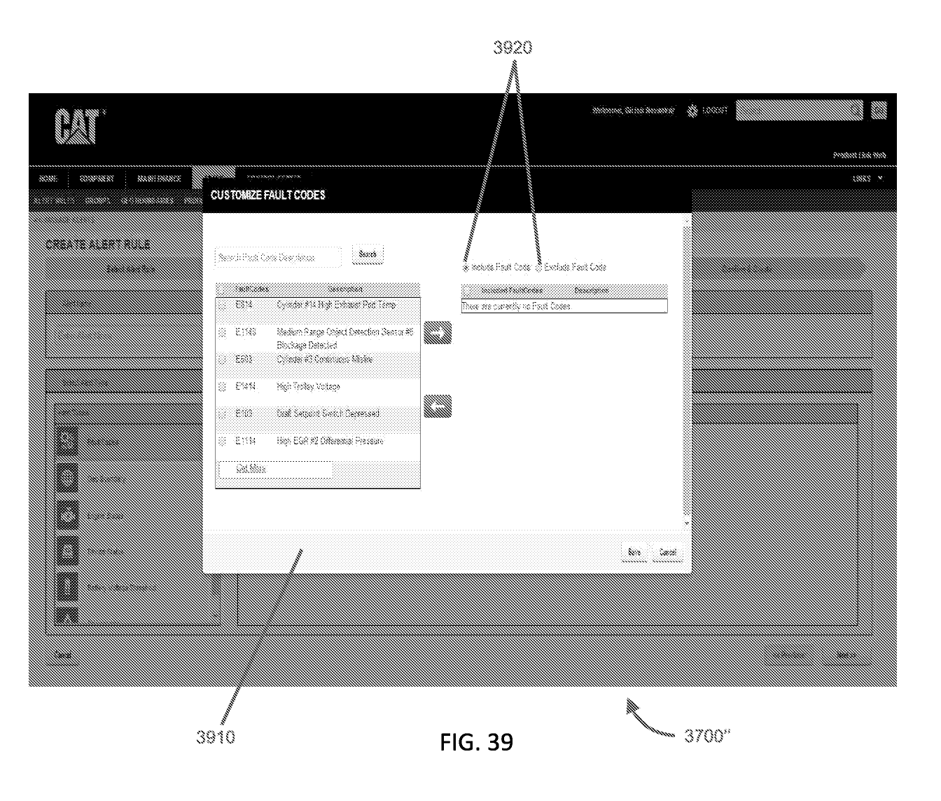

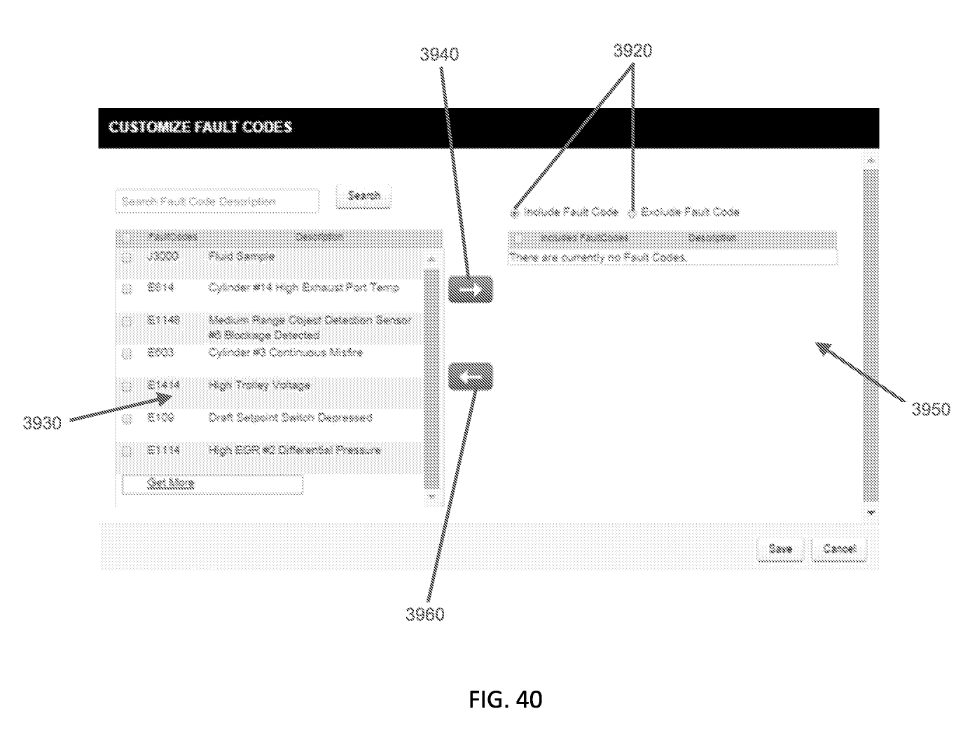

Referring to FIGS. 39 and 40, if the customization of fault mode option 3770 is selected from FIG. 38, a customization pop-up window 3910 may be displayed over a create alert rule page 3700′ of FIG. 38. The customization pop-up window 3910 may allow a user to select fault codes to include or exclude, and an alert will only be provided for the fault codes that are selected. In one aspect, the fault codes that are excluded will not provide an alert. In one aspect, the include and exclude selection options may be in the form of radio buttons 3920.

As shown in FIG. 40, the customization pop-up window 3910 may include a list of fault codes 3930 which may be monitored. In one aspect, one or more of the fault codes from the list of fault codes 3930 may be selected and added to a current alert rule by highlighting or checking a desired fault code and then selecting a first button 3940. The fault code may then be moved to a selected list 3950. A fault code on the selected list 3950 may be removed from the current alert rule by selecting the highlighting or checking the desired fault code on the selected list 3950 and selecting a second button 3960.

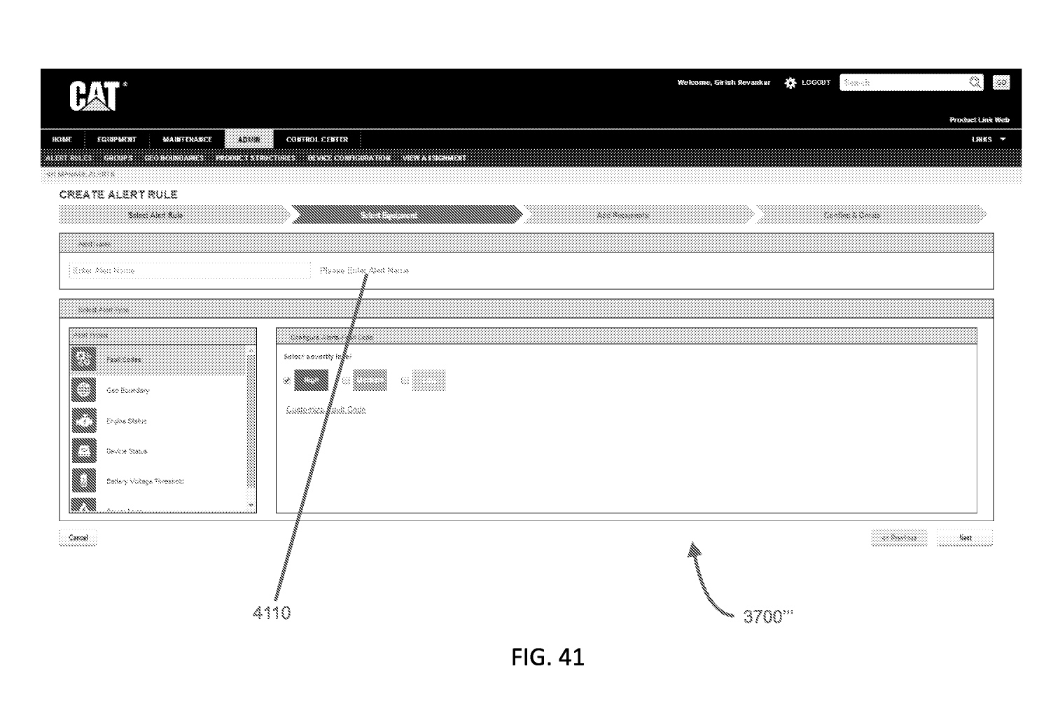

Referring to FIG. 41, a create alert rule page 3700′″ may display an error message 4110 if a user attempts to proceed to a next step by selecting the next button 3750 without inputting all necessary information. For example, if an alert name is not entered into the alert name panel 3720, the user interface may prevent the user from proceeding to a next process or page of the alert creation. In one aspect, an error message 4110 may prompt a user to enter an alert name.

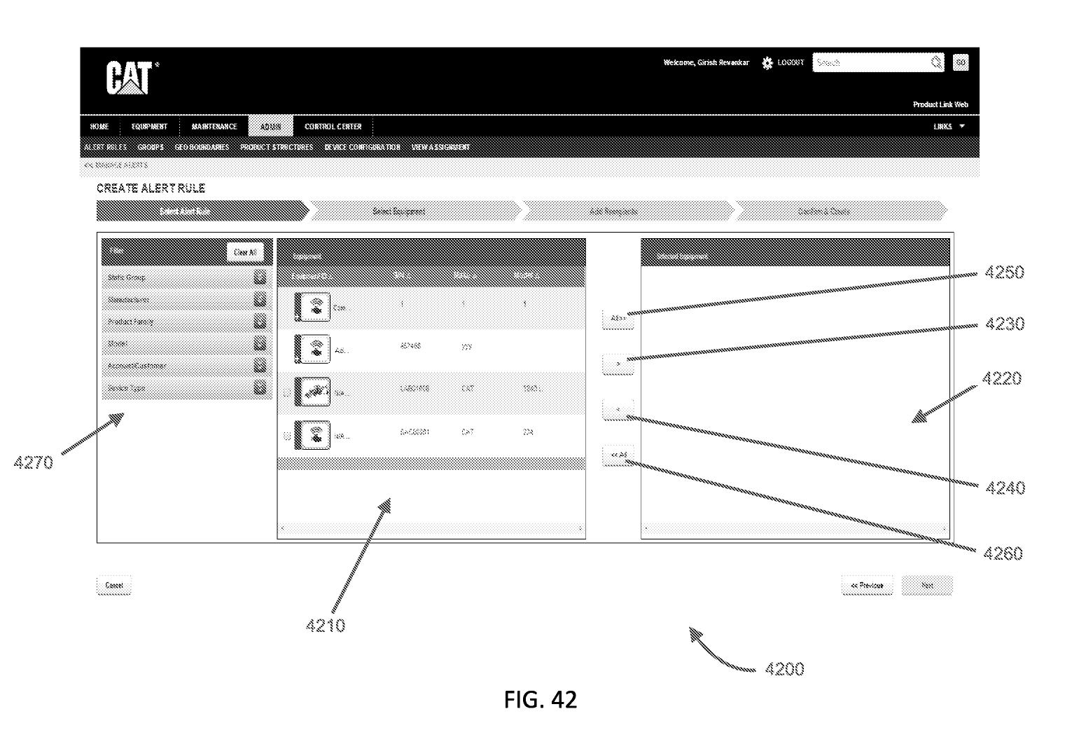

Referring to FIG. 42, a create alert rule page 4200 may include at least a first selection sub-panel 4210 and a second sub-selection panel 4220. The second sub-selection panel 4220 may represent a selected equipment list to be associated with a current alert rule. Individual pieces of equipment may be added or removed from the second sub-selection panel 4220 by selecting a right arrow button 4230, or a left arrow button 4240. In one aspect, all the equipment may be added or removed from the second sub-selection panel 4220 by selecting an add all arrow button 4250 or a remove all arrow button 4260. In one aspect, buttons 4230, 4240, 4250, 4260 may be located between the first selection sub-panel 4210 and the second sub-selection panel 4220. In one aspect, the create alert rule page 4200 may include a filter sub-panel 4270 to filter down the list of equipment to be displayed in the first selection sub-panel 4210. In one aspect, the filter sub-panel 4270 may include one or more of the following equipment filters: static group, manufacturer, product family, model, account/customer, and device type. In some instances a user may have over 90,000 piece of equipment in which they manage, for example, and the filter sub-panel 4270 may enable the user to more quickly filter equipment that they are interested in creating an alert rule for. In one aspect, the first selection sub-panel 4210 is dynamically updated and populated with relevant equipment once one or more filters in the filter sub-panel 4270 have been selected.

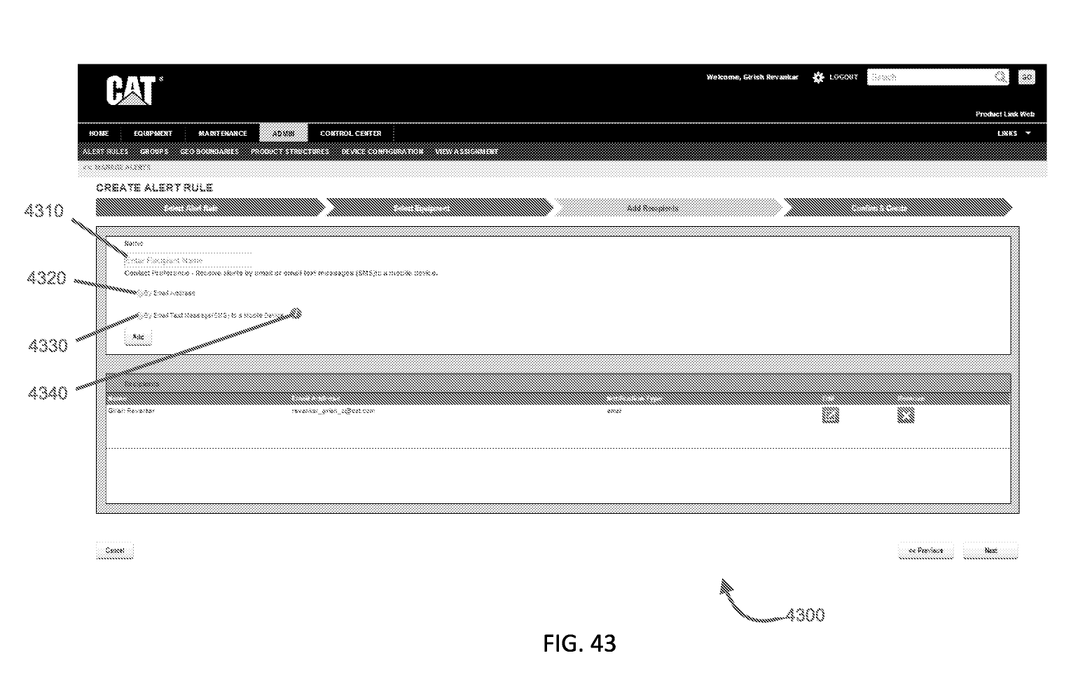

Referring to FIG. 43, a create alert rule page 4300 may display an add recipient option. In one aspect, the create alert rule page 4300 may include a recipient input box 4310 for entering a name of a user who will be receiving the created alerts. In one aspect, the alert rule page 4300 may include radio buttons 4310, 4320 to add email and/or text message contact information such that alerts may be sent via the provided email and/or text message contact information. In one aspect, an information button 4340 may be provided to provide additional tips or information on how an input should be formatted.

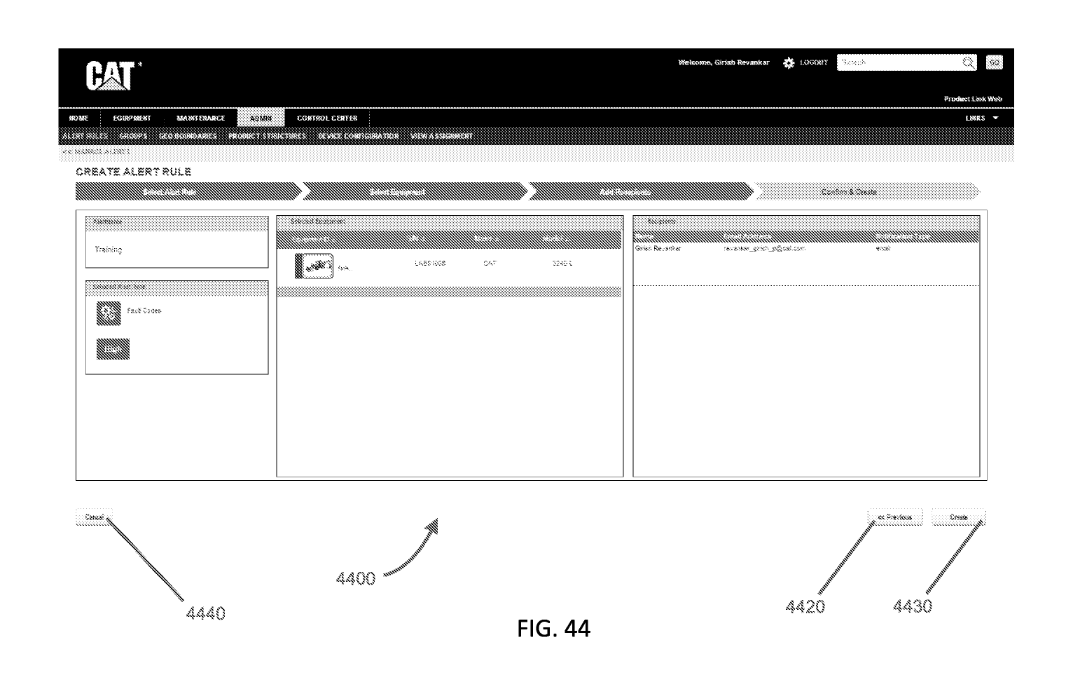

Referring to FIG. 44, a confirmation alert rules page 4400 may display details of an alert type a user wishes to create. In one aspect, the confirmation alert rules page 4400 may include a plurality of previous wizard header tabs 4411, 4412, 4413, which a user may select to return to a previous rule creation process or page. In one aspect, the confirmation alert rules page 4400 may include a previous button 4420, which a user may select to return to a previous rule creation process or page. In one aspect, the confirmation alert rules page 4400 may include a create button 4430 to finalize the rule creation process. In one aspect, the confirmation alert rules page 4400 may include a cancel button 4440 to cancel the rule creation process, without saving any information, and may return the user to the manage alert rules page 3600, as shown in FIG. 36.

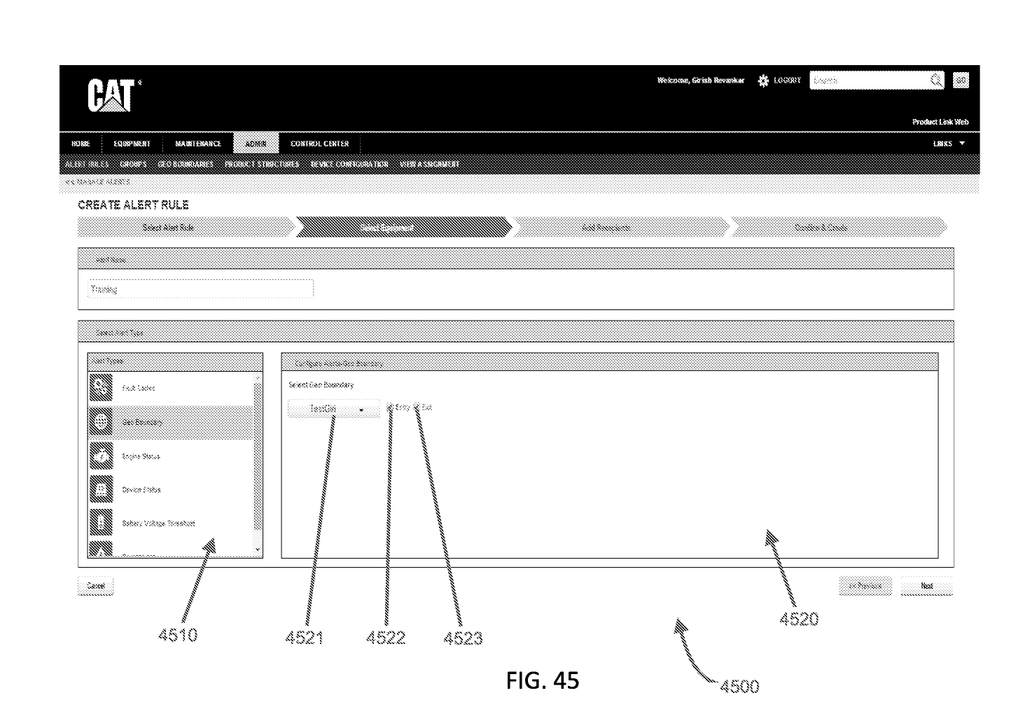

Referring to FIG. 45, a create alert rule page 4500, similar to the create alert rule page 3700 of FIG. 37, may allow a user to create an alert rule using a wizard style interface. In FIG. 45, a geo boundary alert type is selected from an alert type panel 4510. A configure alerts geo boundary panel 4520 may be displayed to provide a user with geo boundary alerts options. In one aspect, the geo boundary panel 4520 may include a drop down menu 4521, which may include a list of selectable predefined geo boundaries. In one aspect, an entry selection check box 4522 and/or an exit selection check box 4523 may be provided adjacent to the drop down menu 4521. In one aspect, the entry selection check box 4522 may be checked to indicate that an alert should be provided when the selected equipment enters the selected geo boundary. In one aspect, the exit selection check box 4523 may be checked to indicate that an alert should be provided when the selected equipment exits the selected geo boundary.

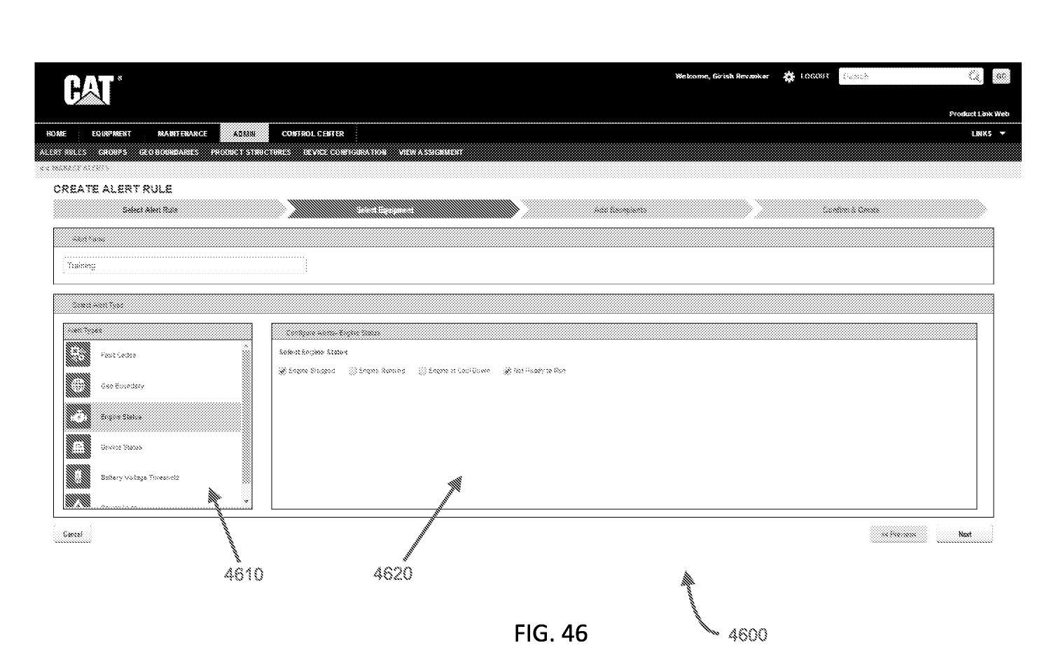

Referring to FIG. 46, a create alert rule page 4600, similar to the create alert rule page 3700 of FIG. 37, may allow a user to create an alert rule using a wizard style interface. In FIG. 46, an engine status alert type is selected from an alert type panel 4610. A configure alerts engine status panel 4620 may be displayed to provide a user with engine status alert options. The configure alerts engine status panel 4620 may include a check box selection for one or more of an engine stopped status, an engine running status, an engine in cool down status, and a not ready to run status.

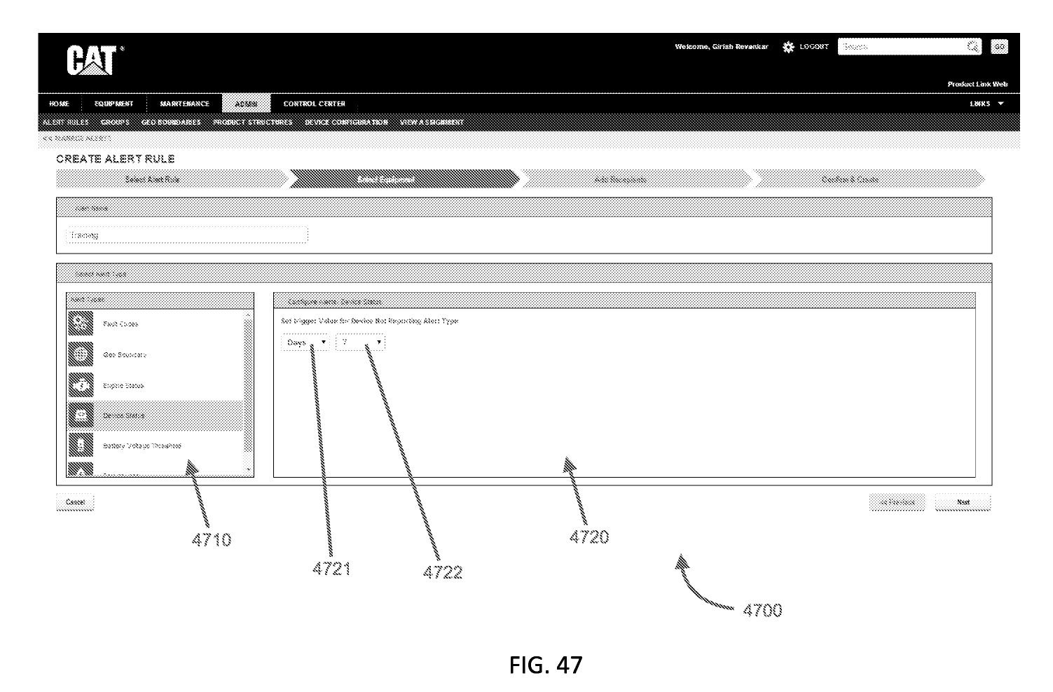

Referring to FIG. 47, a create alert rule page 4700, similar to the create alert rule page 3700 of FIG. 37, may allow a user to create an alert rule using a wizard style interface. In FIG. 47, a device status alert type is selected from an alert type panel 4710. A configure alerts device status panel 4720 may be displayed to provide a user with device status alert options. In one aspect, the alerts device status panel 4720 may include an interval drop down selection 4721. The interval drop down selection 4721 may include one or more of hours, days, weeks, months, years selection. In one aspect, the alerts device status panel 4720 may include a duration drop down selection 4722, which may include numerical choices based on a selection in the interval drop down selection 4721. For example, if a “days” selection is chosen in the interval drop down selection 4721, the duration drop down selection 4722 may be populated with integers one through thirty-one, for example. The configure alerts device status panel 4720 may enable a user to set up a trigger value for sending an alert if the associated equipment has not sent a report or update within the time frame selected in the alerts device status panel 4720.

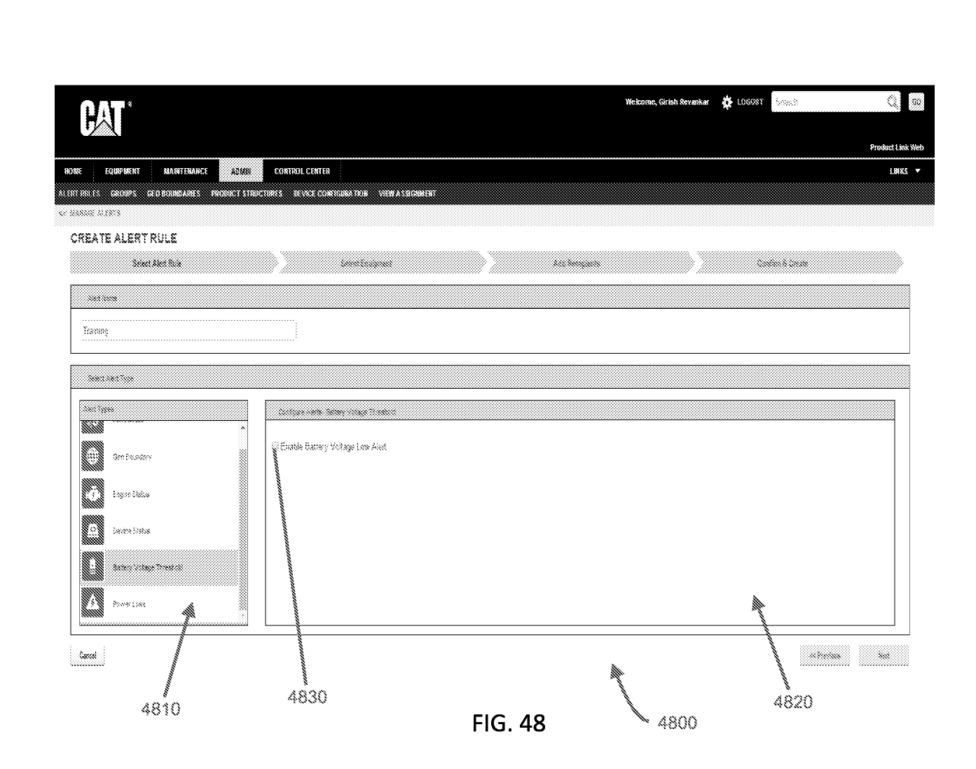

Referring to FIG. 48, a create alert rule page 4800, similar to the create alert rule page 3700 of FIG. 37, may allow a user to create an alert rule using a wizard style interface. In FIG. 48, a battery voltage threshold alert type is selected from an alert type panel 4810. A configure alerts battery voltage threshold panel 4820 may be displayed to provide a user with a battery voltage low alert. In one aspect, the configure alerts battery voltage threshold panel 4820 may include an enable battery voltage low alert check box 4830 to enable an alert if the equipment's battery level falls below a threshold value.

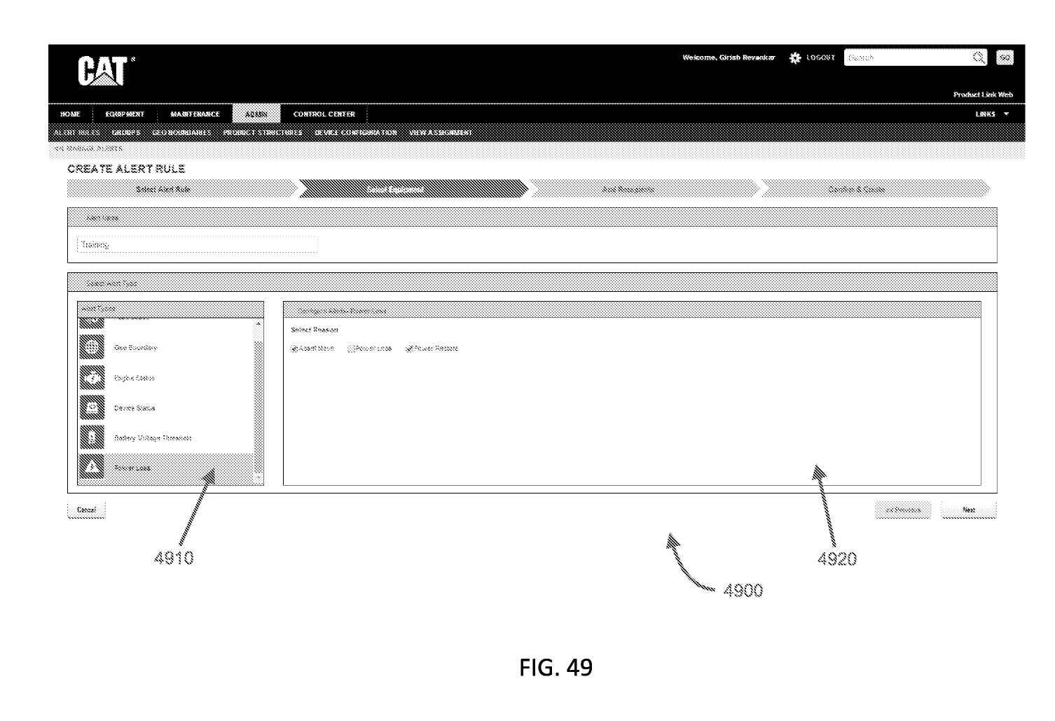

Referring to FIG. 49, a create alert rule page 4900, similar to the create alert rule page 3700 of FIG. 37, may allow a user to create an alert rule using a wizard style interface. In FIG. 49, a battery voltage threshold alert type is selected from an alert type panel 4910. A configure alerts power loss panel 4920 may include a check box selection for one or more of asset move, power loss, and power restore status.

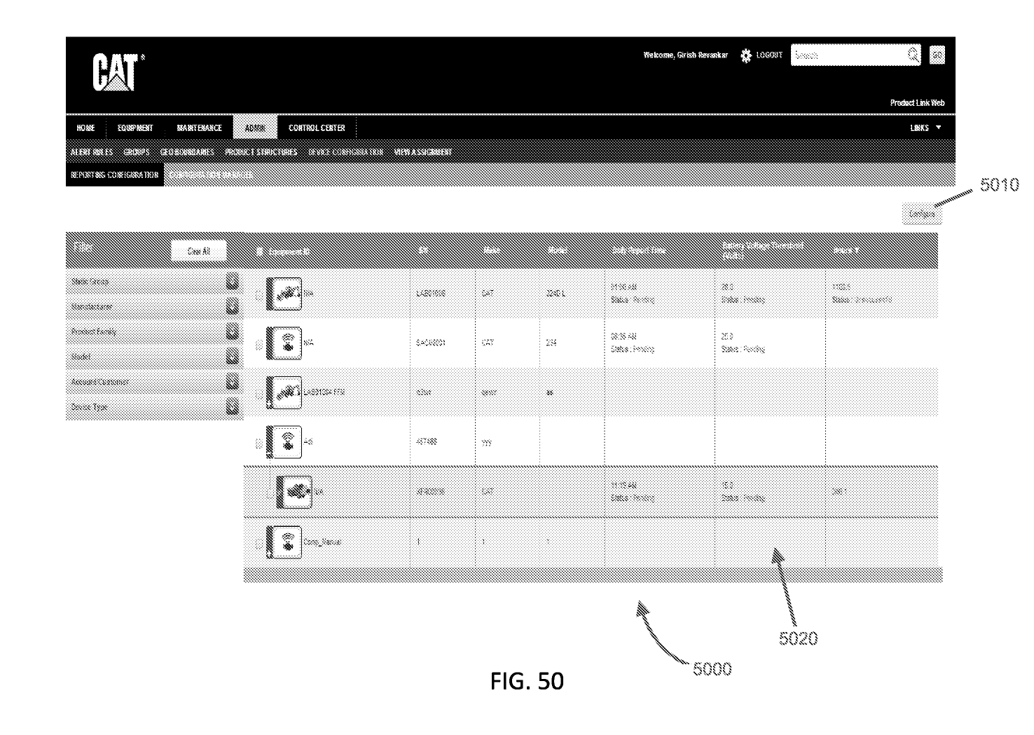

Referring to FIG. 50, a device configuration page 5000 may display a list of equipment and may include a configure button 5010 for device configuration of the listed equipment. In one aspect, the device configuration page 5000 may include a battery voltage threshold column 5020. The list of equipment may be sorted in ascending or descending order by selecting a respective column header. In one aspect, the list of equipment may include one or more icons associated with each piece of equipment of the list of equipment. In one aspect, each icon may have a height and/or width of approximately a height of three to four lines of text which is being displayed in the list of equipment, thus providing an icon that is readily identifiable to a user while allowing the list to accommodate more assets.

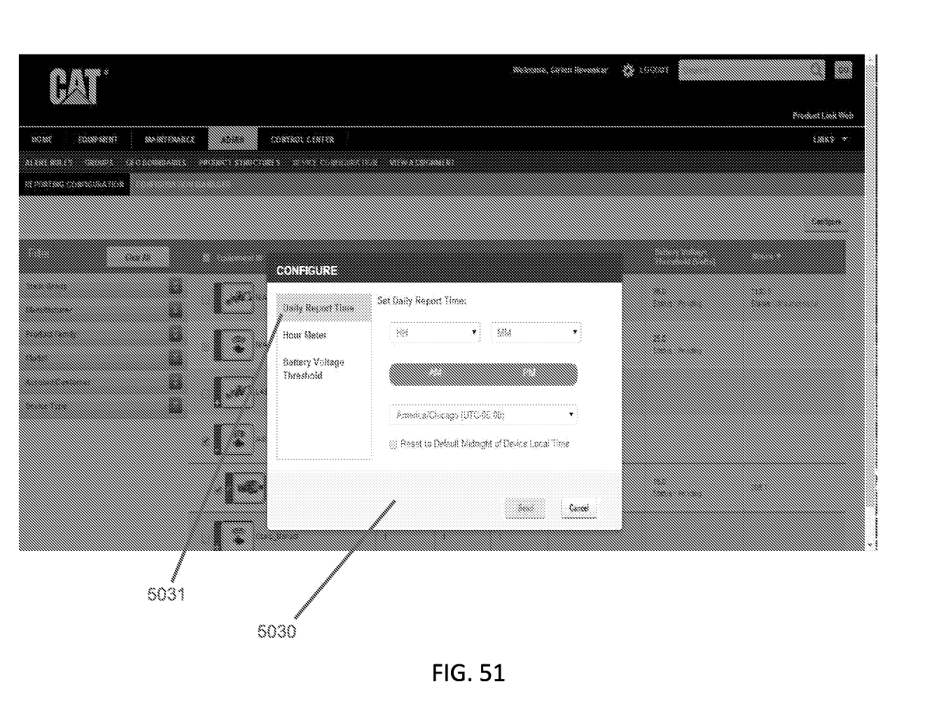

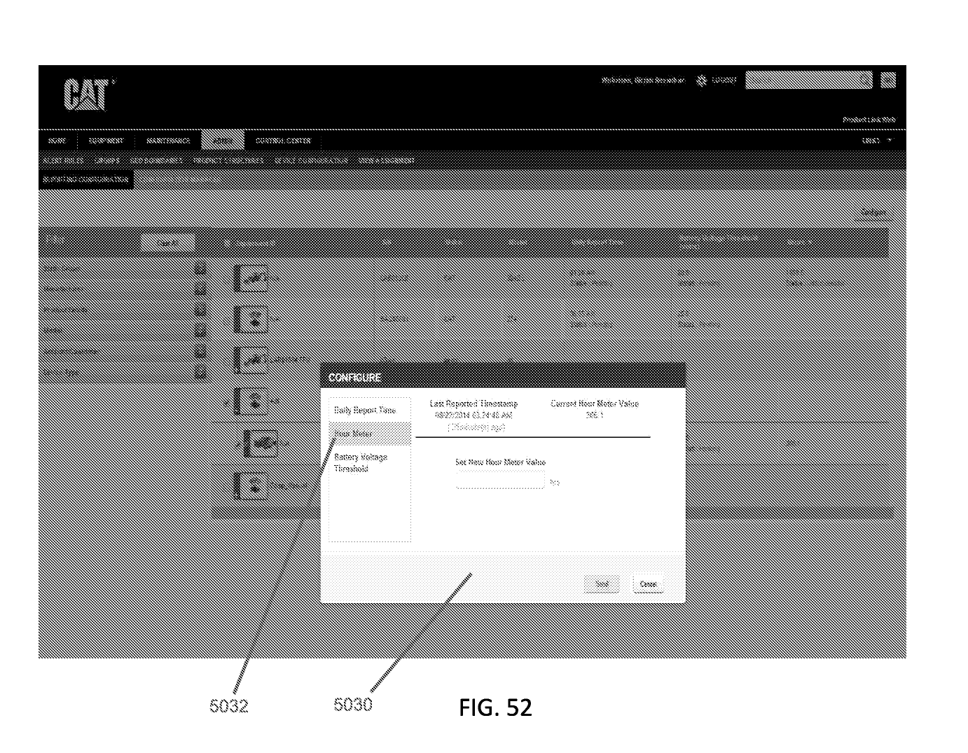

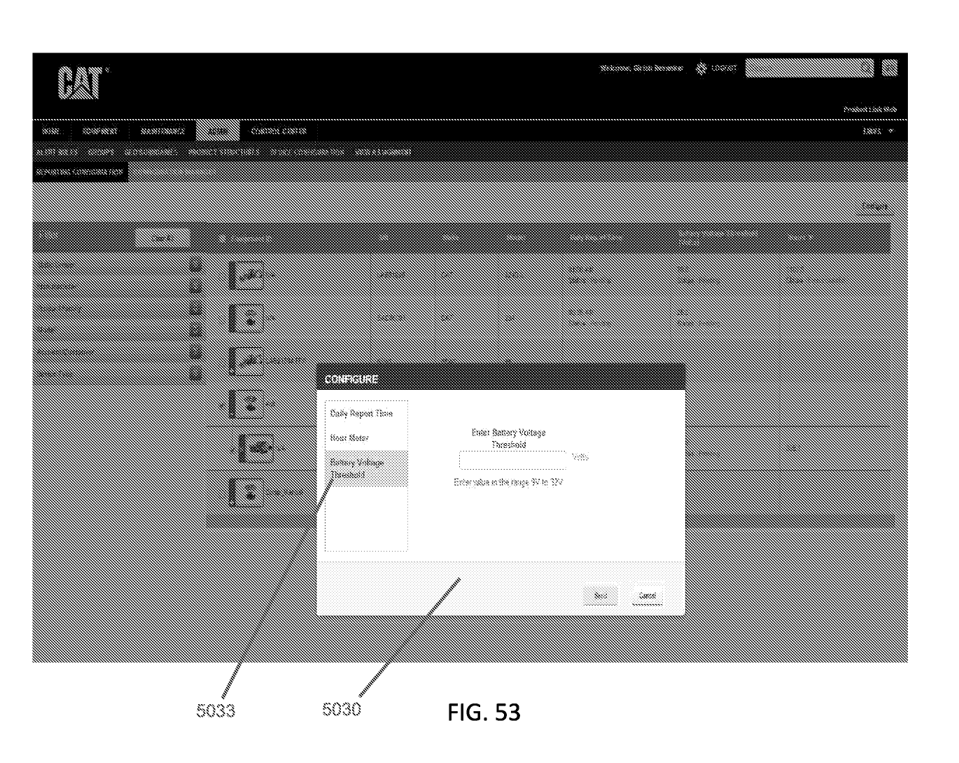

Referring to FIGS. 51-53, a configuration sub-window 5030 may be opened by selecting or clicking on the configure button 5010. The configuration sub-window 5030 may display a daily report time tab 5031, an hour meter tab 5032, and a battery voltage threshold tab 5033. In one aspect, when the daily report time tab 5031 is selected, a daily report time may be set by a user to select a time for when the report is to be delivered. In one aspect, when the hour meter tab 5032 is selected, a new hour meter value may be added. For example, if a piece of equipment is not equipped with a device for tracking work hours, or if the device for tracking work hours is not operation, the hour meter value may be manually added or adjusted. In one aspect, the hour meter tab 5032 may only be available when the device is a master electronic control module (ECM) and only a single piece of equipment is selected. In one aspect, when the battery voltage threshold 5033 is selected, a battery voltage threshold may be set. In one aspect, the battery voltage threshold may be set for multiple pieces of equipment.

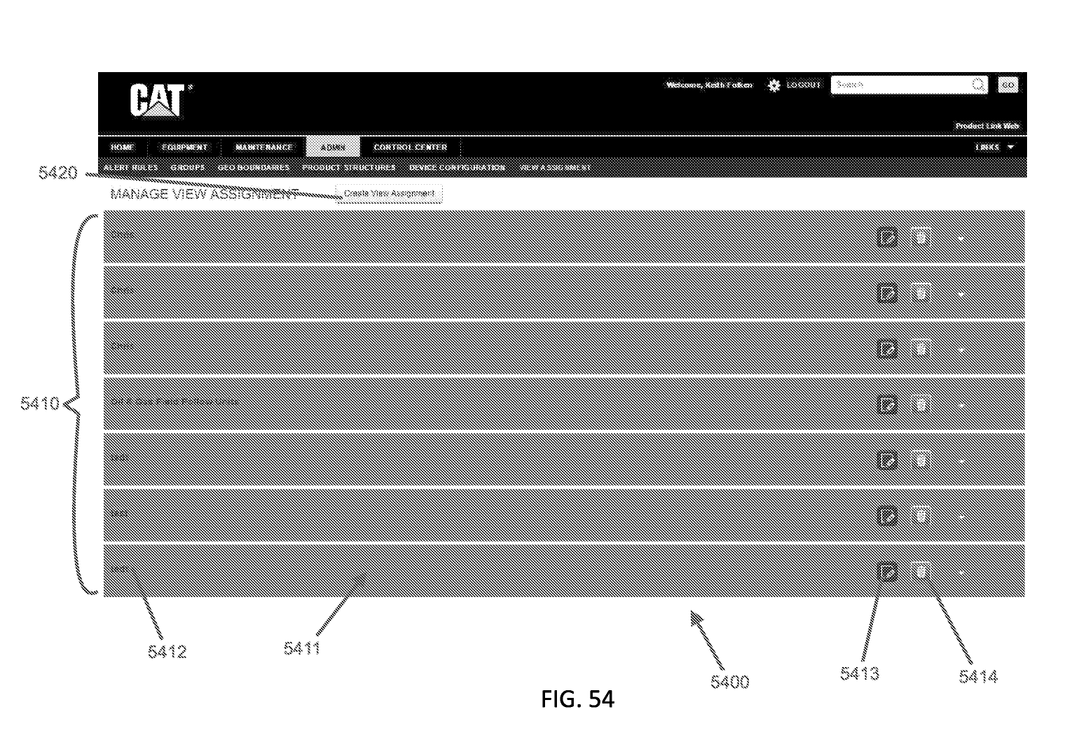

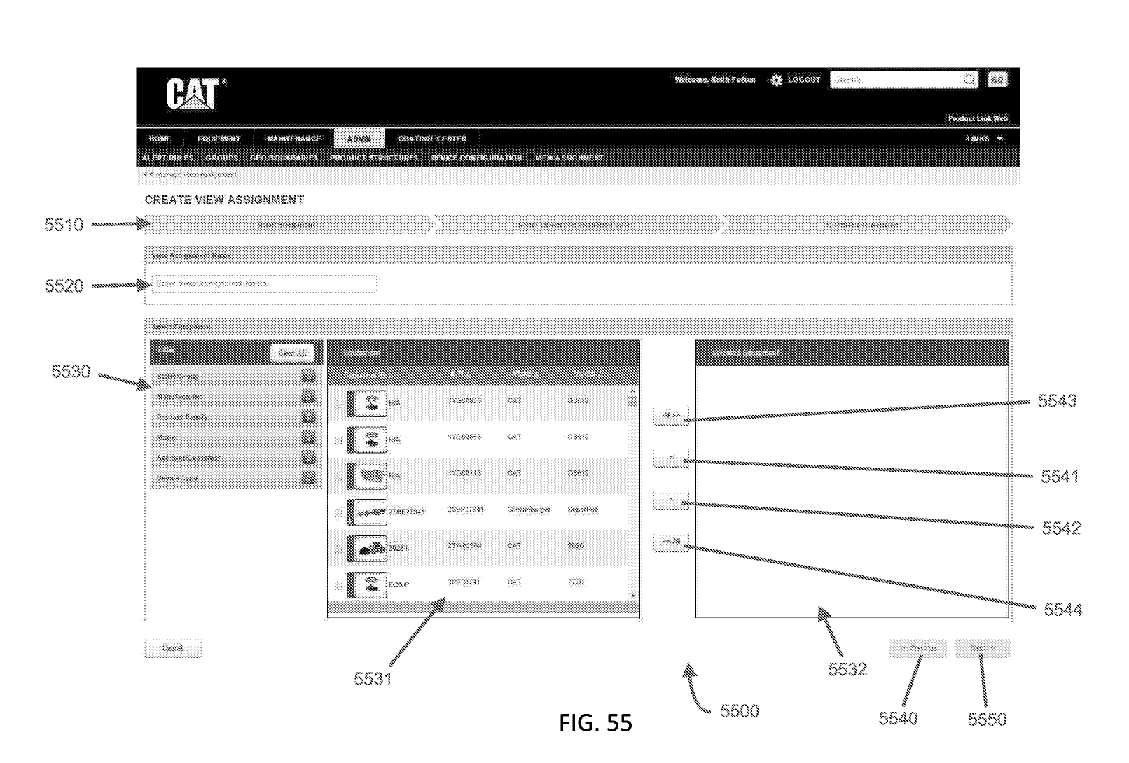

Turning to FIG. 54, a manage view assignment page 5400 may display a list of created view assignments 5410. At least one view assignment 5411 from the list of created view assignments 5410 may include a name or a description 5412. In one aspect, the view assignment from the list of created view assignments 5410 may include an icon, avatar, or photo. In one aspect, the at least one view assignment 5411 may include an edit button 5413 to execute an editing operation and/or a delete button 5414 to delete the at least one view assignment 5411. In one aspect, the manage view assignment page 5400 may include a create view assignment button 5420 to add additional view assignments, which may be displayed on the list of created view assignments 5410. The create view assignment button 5420, when selected, may direct a user to a create view assignment page 5500 of FIG. 55, as will be discussed in detail below.

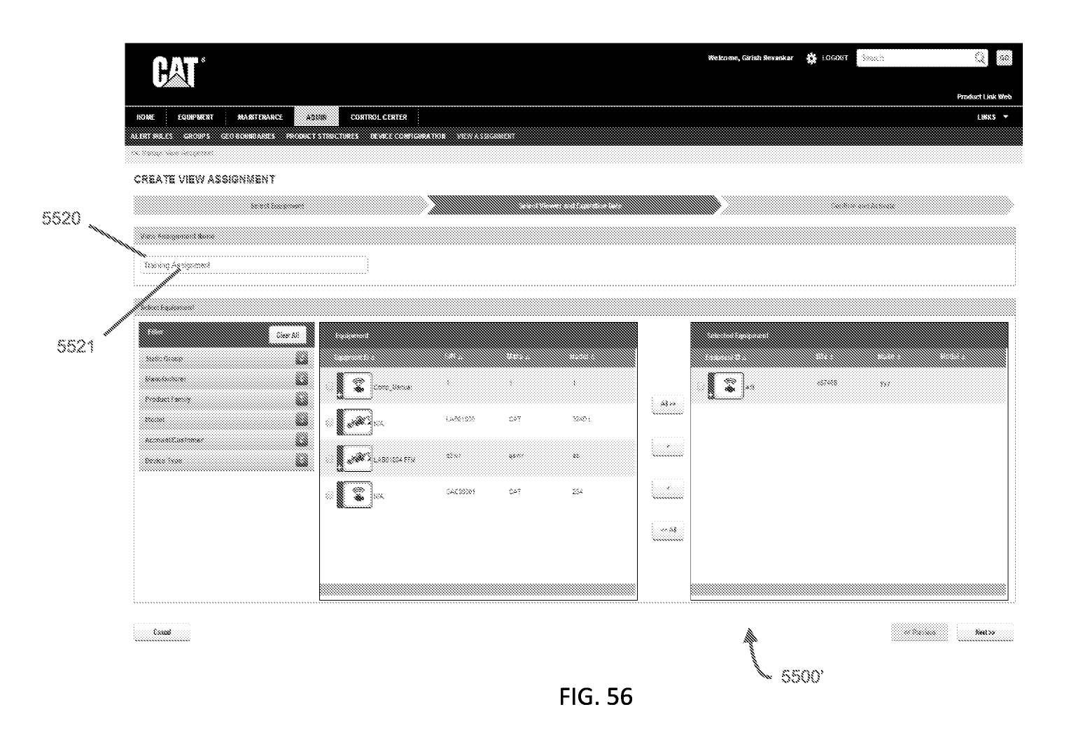

Referring to FIGS. 55 and 56, a create view assignment page 5500 may allow a user to create view assignments using a wizard style interface. As shown in FIG. 55, the create view assignment view page 5500 may include at least a wizard header progress bar 5510, a view assignment name panel 5520, an equipment selection panel 5530, a previous button 5540, and a next button 5550. In one aspect, the equipment selection panel 5530 may include at least a first selection sub-panel 5531 and a second sub-selection panel 5532. The first sub-selection panel 5531 may represent a list of selectable equipment which may be associated with a view assignment, and thus may provide a user with access to the view assignment with permission to view information and/or receive reports associated with equipment that are included in the view assignment. The second sub-selection panel 5532 may represent a selected equipment list. Individual pieces of equipment may be added or removed from the second sub-selection panel 5532 by selecting a right arrow button 5541, or a left arrow button 5542. In one aspect, all the equipment may be added or removed from the second sub-selection panel 5532 by selecting an all-to-the-right arrow button 5543 or an all-to-the-left arrow button 5544. In one aspect, buttons 5541, 5542, 5543, 5544 may be located between the first selection sub-panel 5531 and the second sub-selection panel 5532.

In one aspect, the equipment selection panel 5530 may include a filter sub-panel 5533 to filter down the list of equipment to be displayed in the first selection sub-panel 5531. In one aspect, the filter sub-panel 5533 may include one or more of the following equipment filters: static group, manufacturer, product family, model, account/customer, and device type. In some instances a user may have over 90,000 piece of equipment in which they manage, for example, and the filter sub-panel may enable the user to more quickly filter equipment that they are interested in creating a view assignment for. In one aspect, the first selection sub-panel 5531 is dynamically updated and populated with relevant equipment once one or more filters in the filter sub-panel 5533 have been selected.

Referring to FIG. 56, the view assignment name panel 5520 of the create view assignment page 5500′ may include a text input box 5521. For example, the view assignment name “Training Assignment” may be entered into the text input box. As discussed above, equipment from the first sub-selection panel 5531 may be added to the second sub-selection panel 5532 by selecting equipment in the first sub-selection panel 5531 and selecting the right arrow button 5541. Once the right arrow button 5541 is selected, the selected equipment would then appear in the second sub-selection panel 5532′, as shown in FIG. 56.

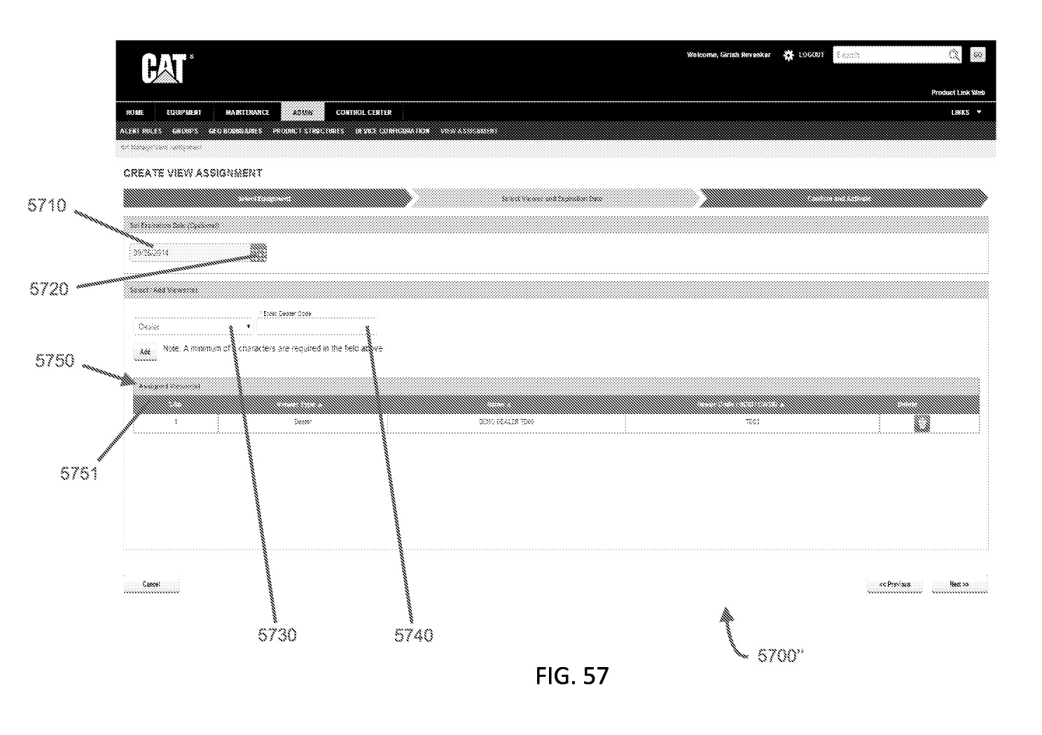

Referring to FIG. 57, a view assignment page 5700 may include an expiration date option. In one aspect, the view assignment page 5700 may include an expiration date text box 5710 for a user to enter an expiration date for when a view assignment is set to automatically expire. In one aspect, a calendar button 5720 may be disposed next to or adjacent to the expiration date text box 5710. The calendar button 5720 may generate a pop-up window with an interactive calendar where a user may click on a date on the calendar to choose an expiration date. In one aspect, if no date is entered or selected, then the view assignment will not automatically expire.

The view assignment page 5700 may include a user type selection 5730 to select or add viewers associated with a view assignment. In one aspect, the user type selection 5730 may be a drop down menu, which may include a dealer, a customer, and a user selection. In one aspect, a dealer code text box 5740 may be provided for entry of a valid dealer code to associate or validate a view assignment with a valid dealer, customer, and/or user. In one aspect a valid dealer code, customer universal identification (UCID), and/or corporate web security identification (CWSID) may be required to confirm whether a selected view has permission to view or access information associated with the equipment for the current view assignment being created. Once an entry has been selected using the user type selection 5730 and a code has been entered into the dealer code text box 5740, the dealer, customer, or user may then be added as an assigned viewer using an add button 5750. In one aspect, the assigned viewer may be populated in an assigned viewers section 5750 once the viewer has been added. In one aspect, the assigned viewers section 5750 may include a header 5751 with sortable columns. The header 5751 may include one or more of the following columns: serial number, viewer type, name, dealer code/UCID/CWSID, and a delete option.

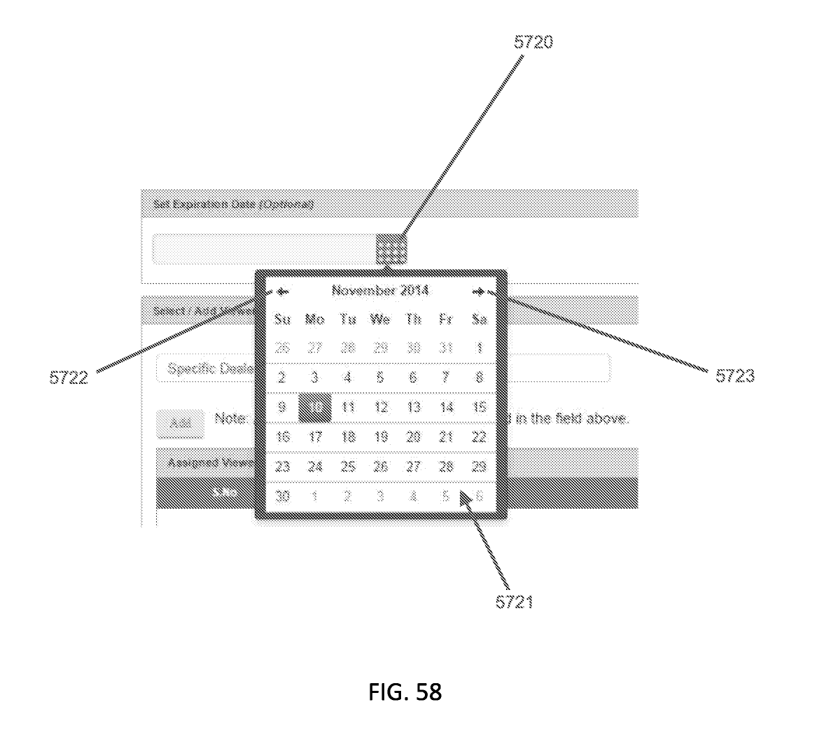

In one aspect, when the calendar button 5720 is selected, an interactive pop-up calendar 5721 may be displayed, as shown in FIG. 58. The calendar 5721 may include a backward arrow 5722 and a forward arrow 5723 to move the calendar forwards or backwards. A user may click or select a day on the calendar 5721 to set as the expiration date of the view assignment. Once a date is selected on the calendar 5721, the month, day, and year information may then be automatically populated into a calendar text field 5724, which may be located adjacent to the calendar button 5720. As an alternative, a user may manually type in an expiration date in the calendar text field 5724.

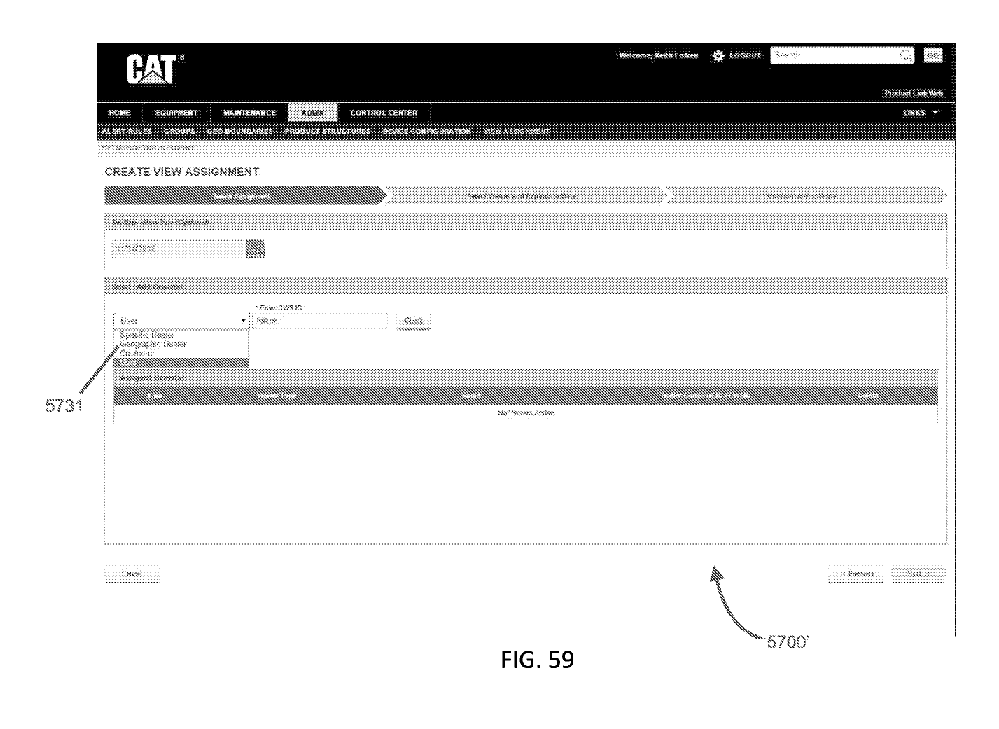

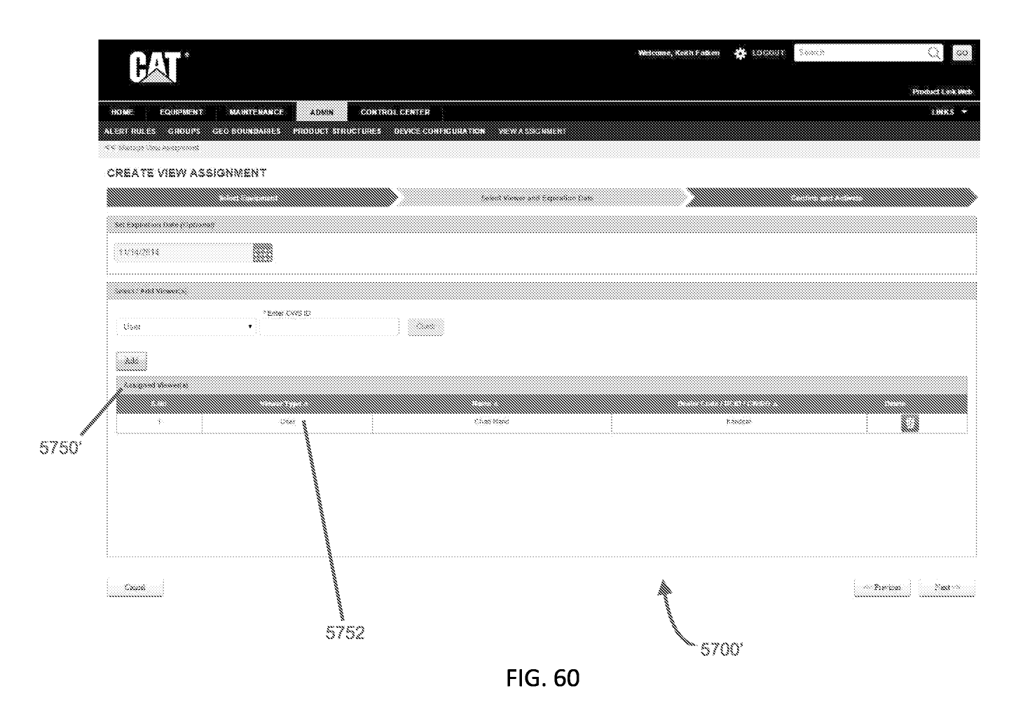

In one aspect, when the user type selection 5730 is selected, a drop down menu 5731 may appear to provide a plurality of user types, as shown in FIG. 59. In one aspect the drop down menu may include one or more of the following user types: specific dealer, geographic dealer, customer, and user. In one exemplary aspect, if a user is selected as the user type and added to the view assignment, the assigned user 5752 may be added to an assigned viewers section 5750′, as shown in FIG. 60.

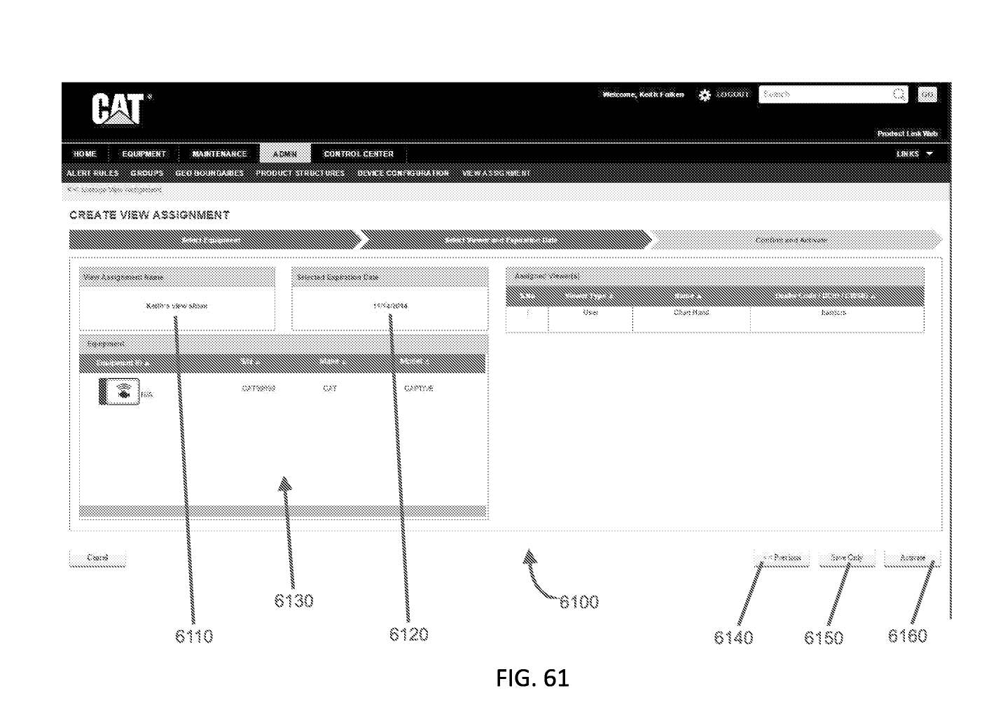

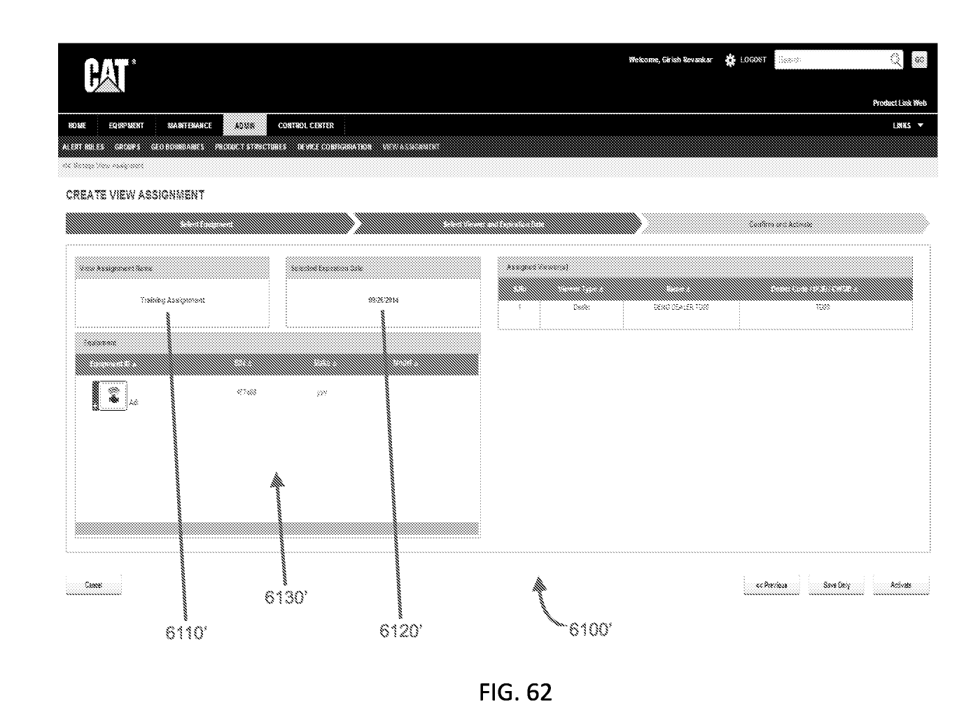

Referring to FIGS. 61 and 62, a view assignment confirmation page 6100 may display to a user all the selections that have been made to the view assignment or assignments. In one aspect, the view assignment confirmation page 6100, 6100′ may include a view assignment name portion 6110, 6110′, a selected expiration date portion 6120, 6120′, and an equipment list 6130, 6130′. In one aspect, the view assignment confirmation page 6100, 6100′ may include a previous button 6140 to return to a previous screen. In one aspect, the view assignment confirmation page 6100, 6100′ may include a save or save only button 6150 such that a view assignment and associated input parameters may be saved in the fleet management web portal system without activating the view assignment. In one aspect, the view assignment confirmation page 6100 may include an activate button 6160 such that the view assignment and associated input parameters are activated.

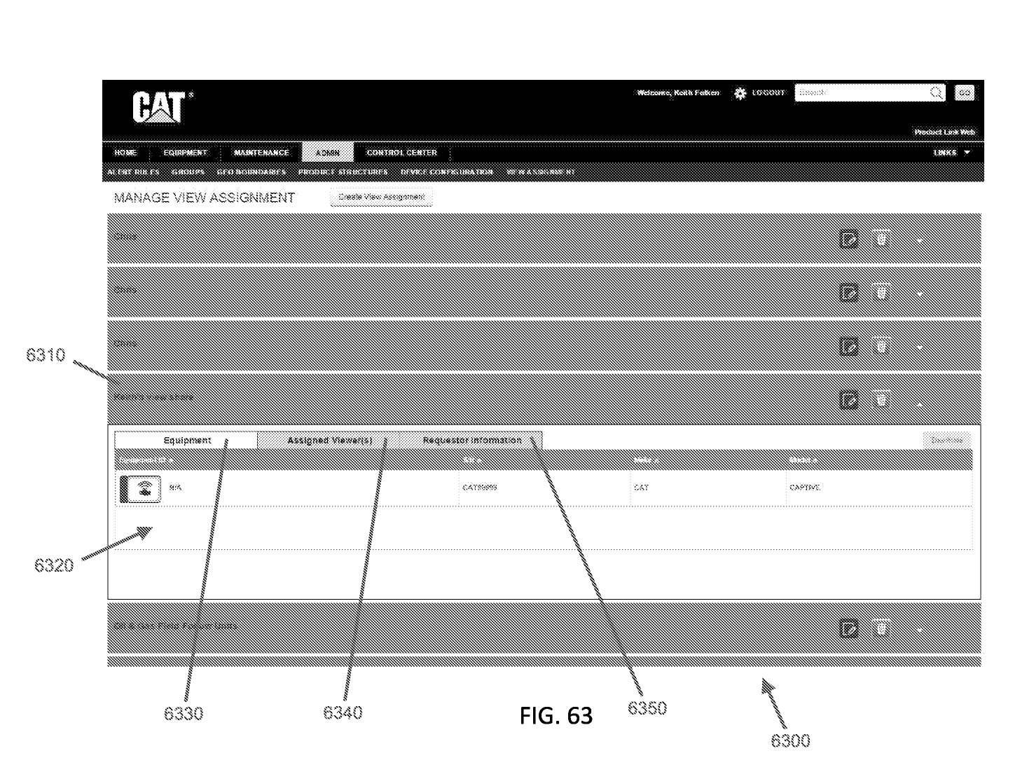

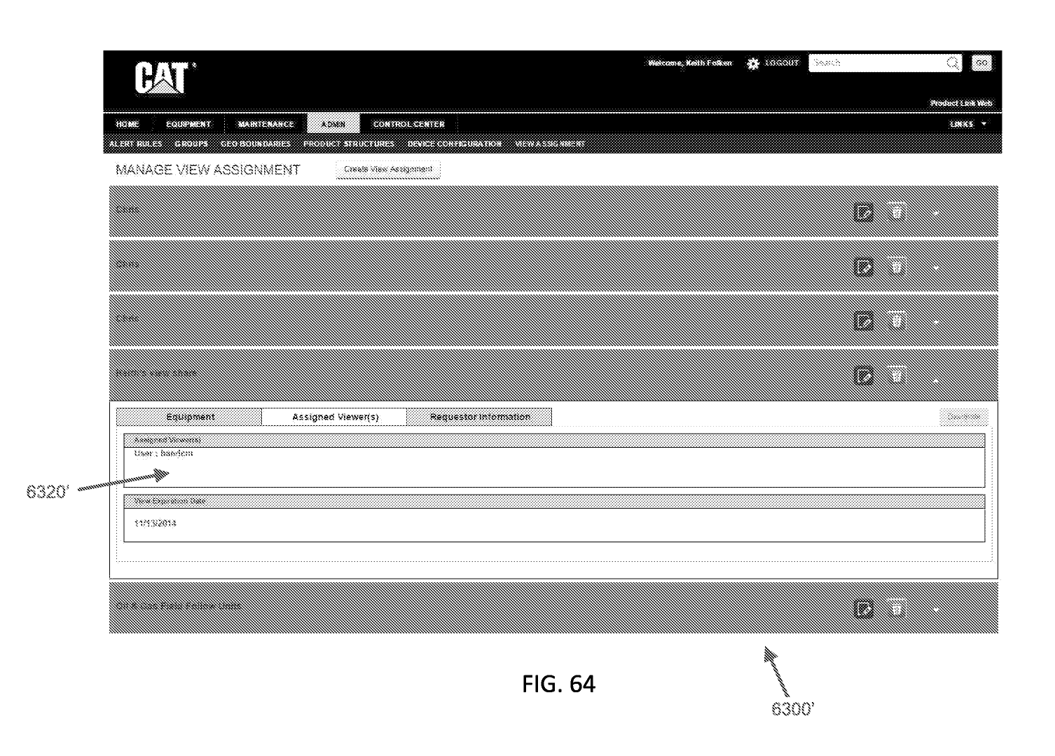

Once a view assignment is activated, a user may be returned to the manage view assignment page 5400, as discussed with respect to FIG. 54. As shown in FIG. 63, the view assignment page 6300 may include one or more view assignment entries 6310, and the one or more view assignment entries 6310 may be selected to provide additional information relating to that particular view assignment entry 6310. When one view assignment entry 6310 is selected, a detailed information section 6320 may be displayed below the view assignment entry 6310. In one aspect, the detailed information section 6320 may include tabs for organizing and displaying information in a clear and compact manner. In one aspect, the detailed information section 6320 may include one or more of an equipment tab 6330, an assigned viewers tab 6340, and a requestor information tab 6350.

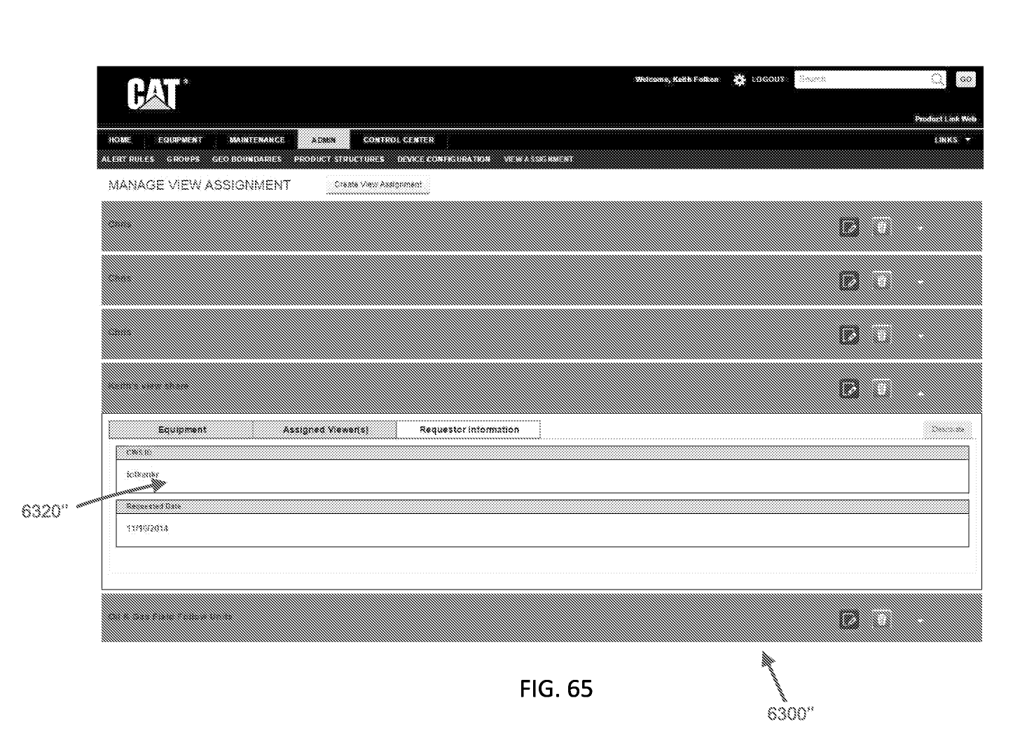

As shown in FIG. 63, when the equipment tab 6630 is selected, information relating to equipment identification, serial number, make, and model may be displayed in the detailed information section 6320. As shown in FIG. 64, when the assigned viewers tab 6340 is selected, one or more assigned viewers or users may be displayed in the detailed information section 6320′. Additionally, a view expiration date may be displayed in the detailed information section 6320′. As shown in FIG. 65, when the requestor information tab 6350 is selected, a requestor name or identification, and a request date may be displayed in the detailed information section 6320″.

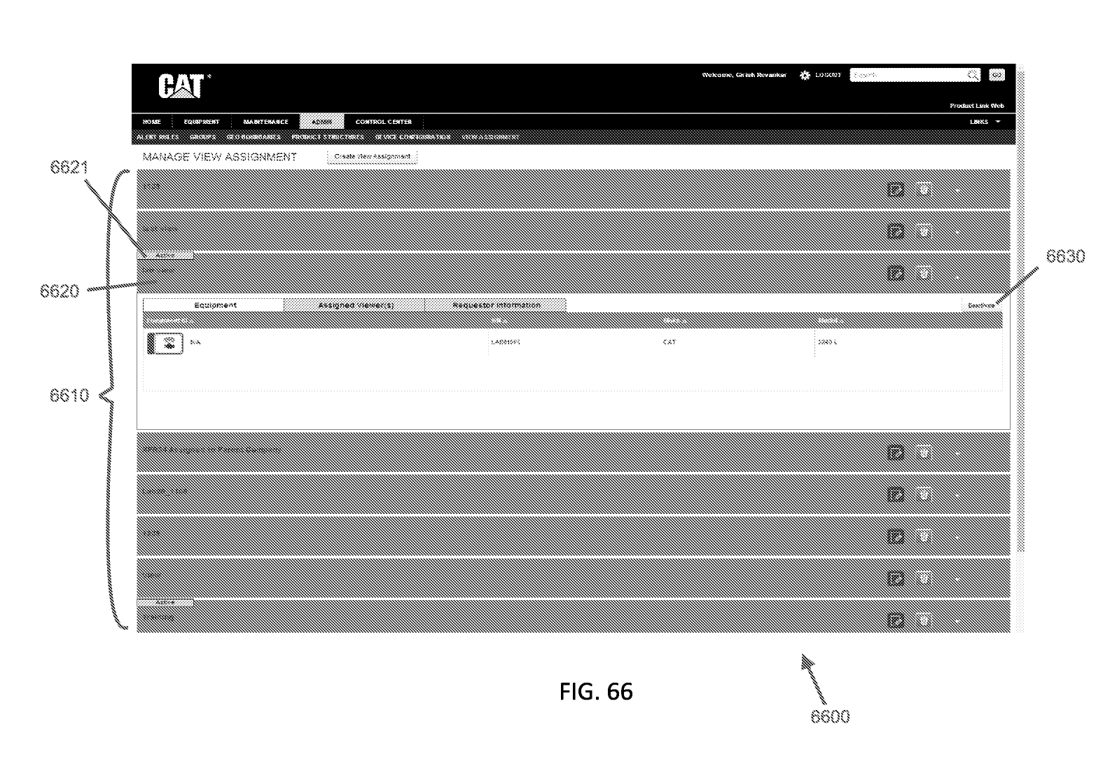

Turning to FIG. 66, a manage view assignment page 6600 may display a list of view assignments 6610, including active and inactive indicators. The manage view assignment page 6600 may include one or more view assignment entries 6620. In one aspect, the view assignment entry 6620 may include an active indicator 6621 to indicate that the view assignment is currently active. In one aspect, the active indicator 6621 may be in the form of a rectangular bar and may be highlighted in a distinguishing color such as a yellow color. Other colors and shapes are of course contemplated. In one aspect, the view assignment entry 6620, which is in an active state, may include a deactivate button 6630 to deactivate the current view assignment entry 6620.

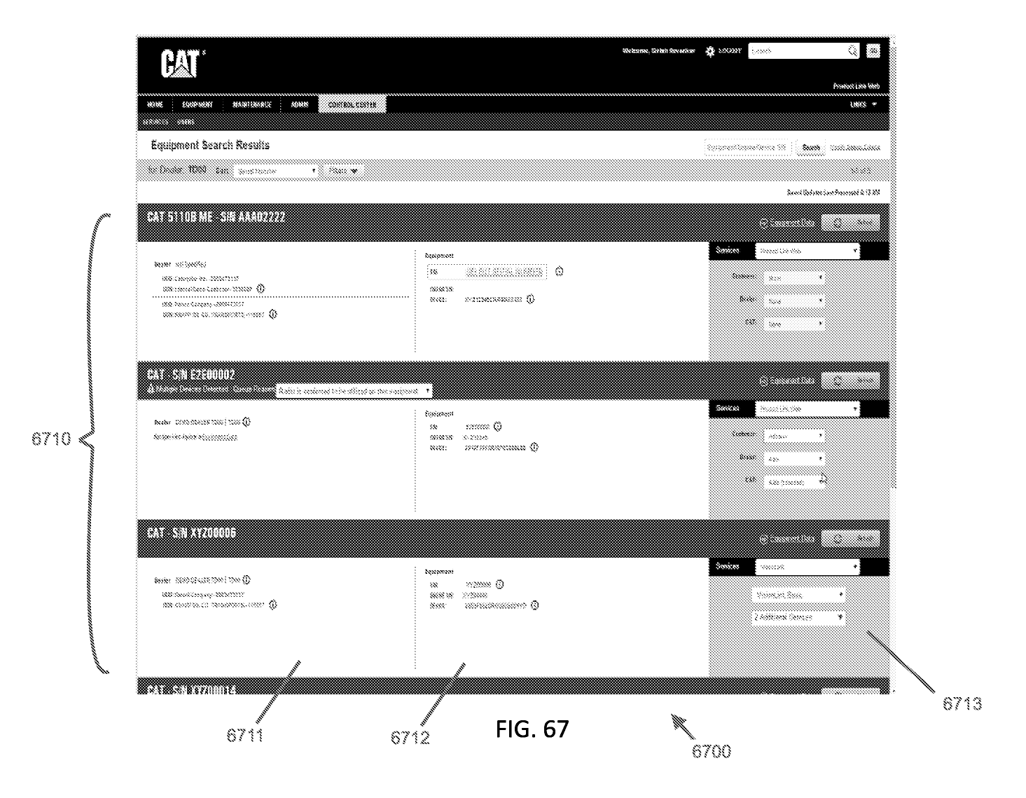

Turning to FIG. 67, an advisor subscription page 6700 may display a list of equipment 6710 and may include associated dealer or user information 6711, equipment information 6712, and subscription or service options 6713. In one aspect, the equipment information 6712 may include one or more of a serial number, an engine identification number, and a device number. In one aspect, the subscription or service options 6713 may allow different subscription or service levels to be selected depending of if the user is a customer, dealer, or manufacturer. In one aspect, subscription options for each piece of equipment may be added or modified by a dealer, customer, and/or user.

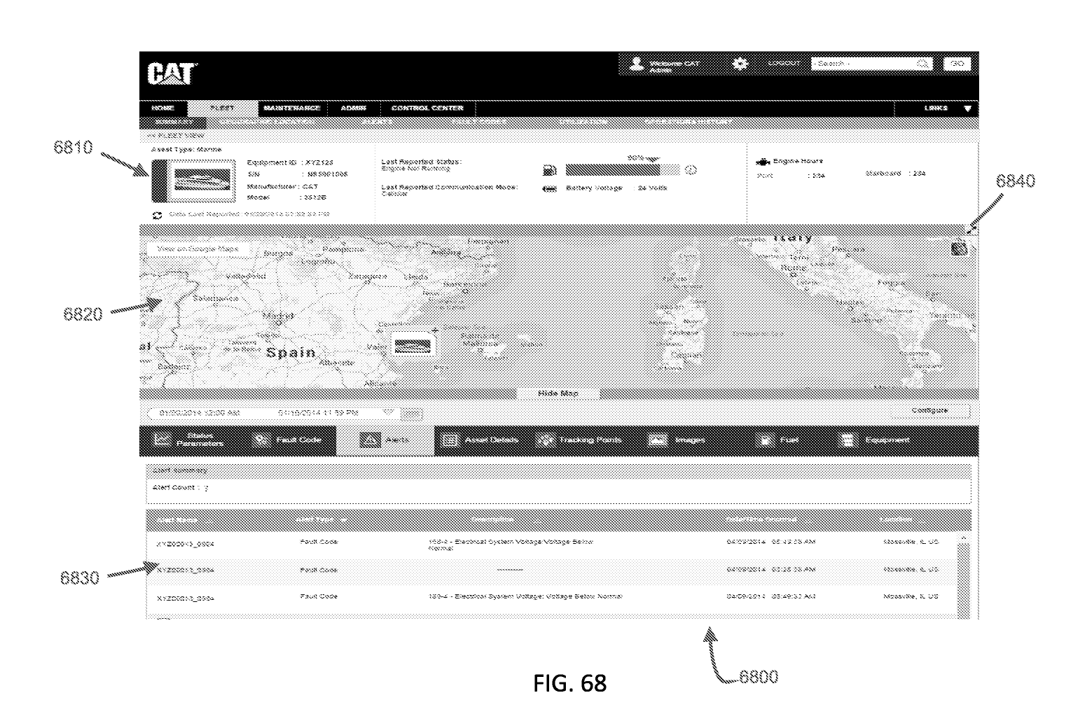

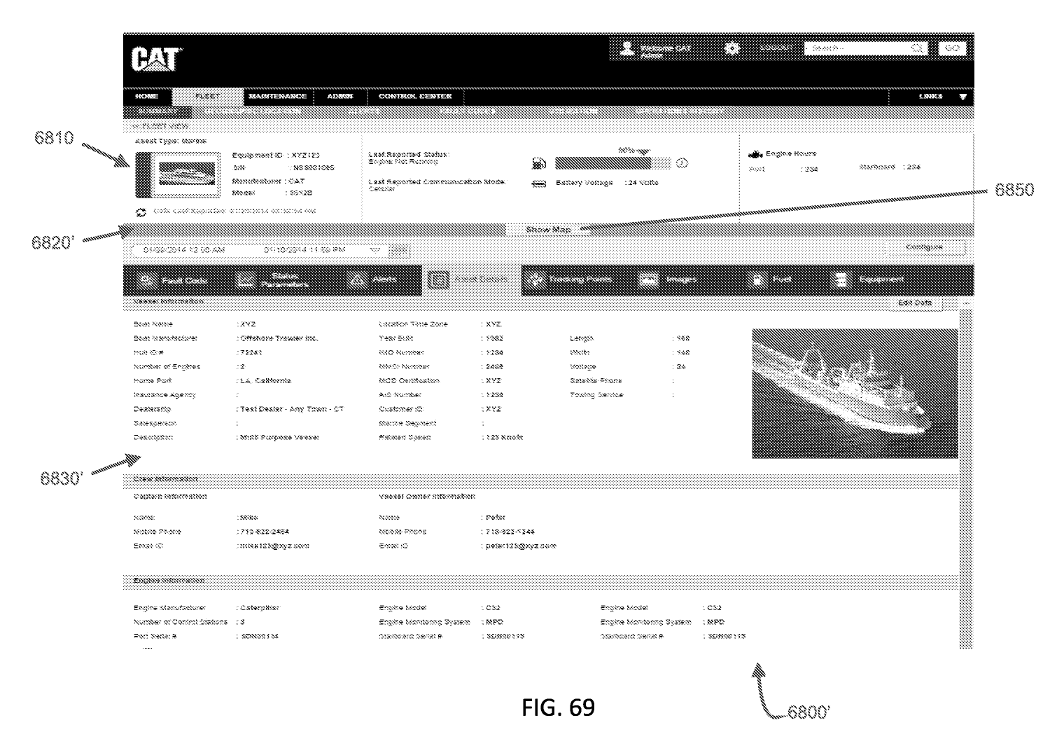

Turning to FIGS. 68 and 69, a general graphical user interface layout for a home screen page 6800 of a second management solution portal or a fleet management web portal. In one aspect, the home screen page 6800 may be used for marine equipment application. However, other equipment applications using the home screen page 6800 are contemplated. In one aspect, the home screen page 6800 may include a first panel 6810, a second panel 6820, and a third panel 6830, as shown in FIG. 68. The first panel 6810, the second panel 6820, and the third panel 6830 may be horizontally arranged and stacked upon one another.

In one aspect, the first panel 6810 may be used to display equipment operating parameters. In one aspect, the second panel 6820 may be used to display a map or geographic information. In one aspect of the second panel 6820, may include a resize button 6840 to minimize the second panel 6820. In one aspect, the third panel 6830 may be used to display report information relating to one or more of status parameters, fault codes, alerts, asset details, tracking points, images, fuel, and equipment. In one aspect, when the resize button 6840 is selected, the second panel 6820′ may be minimized to increase space for the third panel 6830′, as shown in FIG. 69. The second panel 6820′, when minimized, may include an expand or show map button 6850 to return to a layout similar to that of FIG. 68, for example.

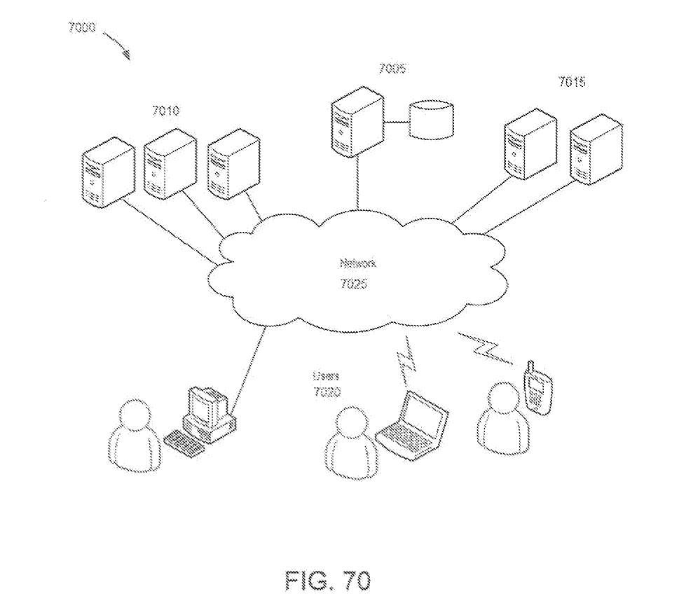

FIG. 70 is a block diagram of an exemplary fleet management system 7000. The fleet management system 7000 may include a web portal system 7005, a first fleet of equipment 7010, a second fleet of equipment 7015, and users 7020. The first fleet of equipment 7010 may include one or more pieces of equipment that each includes wired or wireless communication capabilities to report a status or other information pertaining to that piece of equipment. The second fleet of equipment 7015 may include one or more pieces of equipment that each includes wired or wireless communication capabilities to report a status or other information pertaining to that piece of equipment. Of course, additional fleets of equipment for connecting to the fleet management system are contemplated.

In one aspect, the web portal system 7005 may retrieve information from the first fleet of equipment 7010 and/or second fleet of equipment 7015, format the retrieved information into one or more screens, including generation of one or more of the graphical user interfaces discussed above, and transmit the one or more screens to one or more users 7020. In one aspect, the web portal system 7005 may transmit the one or more screens to one or more electronic devices of the users 7020, the electronic devices including at least a display screen.

### INDUSTRIAL APPLICABILITY

The disclosure is applicable to a user interface for a management solution, and more particularly to a user interface for a fleet management web portal to manage a fleet of machines and/or equipment.

FIGS. 1-69 show user interfaces for the fleet management web portal that may be displayed on an electronic device to allow a user to view and manage alerts associated with a fleet of equipment that is linked to the fleet management web portal.

In one aspect, the fleet management web portal may include an interactive interface and/or database which may be hosted on one or more servers located at one or more sites. The fleet management web portal may be used to store, receive and/or distribute data and information relating to a single piece of machine or equipment, or a fleet of machines and equipment. The fleet management web portal may enable operators to access up-to-date and relevant information relating to their equipment to improve operating efficiency and reduce cost.

In one aspect, the fleet management web portal may be accessed with an electronic device, such as but not limited to, a desktop computer, a laptop, a tablet, a mobile phone, computing devices, mobile smartphones, etc: The electronic device may include at least a display screen and at least one input device. Referring to FIGS. 1-69, the user interfaces may include alerts overlaid on top of geographic information, such as a map, for easy identification by a user. In one aspect, the user interfaces of FIGS. 1-69 may include a variety of inputs such as text box inputs, check boxes, radio buttons, drop down menus, and/or sorting via column headers, which may provide intuitive input operation regardless of whether a user is accessing the fleet management web portal through a desktop computer or through a mobile device such as a mobile phone or tablet.

In one aspect, referring to FIGS. 27 and 31, colors may be used in association with severity levels and/or tracking points to provide additional information without taking up additional space on a display screen. In one aspect, referring to FIGS. 23-25, different equipment summary pages may be used to display a list of equipment depending on a type of electronic device in order to display the equipment information in a clear and responsive manner.

In one aspect, referring to FIGS. 20-22, an icon 2000, 2100, 2100′, 2210, 2220 may have a respective sidebar 2010, 2110, 2110′, 2211, 2221 which may include an indicator to convey additional information. In one aspect, the sidebar 2110 of icon 2000 in FIG. 21, representing a piece of equipment, may be selected to display one or more icons 2210, 2220, representing associated sub-equipment, as shown in FIG. 22.

Referring to FIG. 20, a first exemplary icon 2000 may be used to depict a piece of equipment. The icon 2000 may include a sidebar 2010 and a graphical image 2020. The sidebar 2010 may include an indicator 2030 to convey additional information. In one aspect, the indicator 2030 may be a graphical image of an eye, and may be used to represent that the piece of equipment is assigned to one or more viewers.

Referring to FIG. 70, FIG. 70 shows a block diagram of an exemplary fleet management system 7000. The fleet management system 7000 may include a web portal system 7005, a first fleet of equipment 7010, a second fleet of equipment 7015, and users 7020. The first fleet of equipment 7010 may include one or more pieces of equipment that each includes wired or wireless communication capabilities to report a status or other information pertaining to that piece of equipment. The second fleet of equipment 7015 may include one or more pieces of equipment that each includes wired or wireless communication capabilities to report a status or other information pertaining to that piece of equipment. Of course, additional fleets of equipment for connecting to the fleet management system 7000 are contemplated.

The system further includes a web portal system 7005. The web portal system 7005 operates to at least retrieve information from the first and the second fleet of equipment, and to format the retrieved information for display to the users 7020. Each of these entities can be coupled to a network 625 (e.g., the Internet) using one or more communication channels (e.g., cellular, wireless, optical, Ethernet, satellite).

The functional operations described can be implemented in digital electronic circuitry, or in computer hardware, firmware, software, or in combinations of them. The web portal system 7005 can be implemented in a computer program product tangibly embodied in a machine-readable storage device for execution by a programmable processor. The steps performed by the web portal system 7005 can be performed by a programmable processor executing a program of instructions to perform functions by operating on input data and generating output.

The web portal system 7005 can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

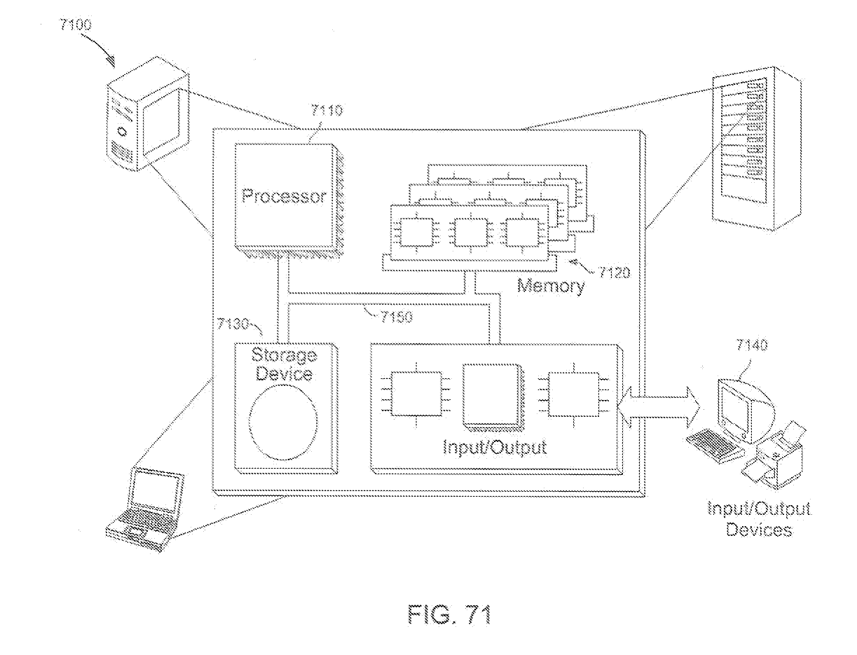

FIG. 71 shows a schematic diagram of an exemplary computer system 7100 that can be used to implement a server hosting the web portal system 7005, the first fleet of equipment 7010, and the second fleet of equipment 7015.

The system 7100 includes a processor 7110, a memory 7120, a storage device 7130, and an input/output device 7140. Each of the components 7110, 7120, 7130, and 7140 can, for example, be interconnected using a system bus 7150. The processor 7110 is capable of processing instructions for execution within the system 7100. In one implementation, the processor 7110 is a single-threaded processor. In another implementation, the processor 7110 is a multi-threaded processor. The processor 7110 is capable of processing instructions stored in the memory 7120 or on the storage device 7130 to display graphical information for a user interface on the input/output device 7140. In some embodiments, a parallel processing set of systems 7100 connected over a network may be employed, clustered into one or more server centers.

The memory 7120 stores information within the system 7100. In one implementation, the memory 7120 is a computer-readable medium. In one implementation, the memory 7120 is a volatile memory unit. In another implementation, the memory 7120 is a non-volatile memory unit.

The storage device 7130 is capable of providing mass storage for the system 7100. In one implementation, the storage device 7130 is a computer-readable medium. In various different implementations, the storage device 7130 can, for example, include a hard disk device, an optical disk device, or some other large capacity storage device.

The input/output device 7140 provides input/output operations for the system 7100. In one implementation, the input/output device 7140 may include one or more of a keyboard, a mouse, a button, a touchpad, a touchscreen, or the like. In another implementation, the input/output device 7140 includes a display unit for displaying graphical user interfaces (GUI) of the fleet management system 7000.

In one aspect, the user interfaces of this disclosure may include or may be usable with communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, Long Term Evolution (LTE), EVolution-Data Optimized (EVDO) and/or the like, and/or a combination of two or more thereof.

The user interfaces of this disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

In one aspect, the user interfaces of this disclosure may be web-based. For example, a server may operate a web application to allow the user interfaces to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

In one aspect, the user interfaces of this disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various aspects of the user interfaces of this disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the user interfaces of this disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the user interfaces of this disclosure is considered to include a tangible storage medium or distribution medium, as listed herein and including art-recognized equivalents and successor media, in which the software implementations herein are stored.

Additionally, the various aspects of the user interfaces of this disclosure may be implemented in a non-generic computer implementation. Moreover, the various aspects of the user interfaces of this disclosure set forth herein improve the functioning of the system as is apparent from the user interfaces of this disclosure hereof. Furthermore, the various aspects of the user interfaces of this disclosure involve computer hardware that it specifically programmed to solve the complex problem addressed by the user interfaces of this disclosure. Accordingly, the various aspects of the user interfaces of this disclosure improve the functioning of the system overall in its specific implementation to perform the process set forth by the user interfaces of this disclosure and as defined by the claims.

It will be appreciated that the foregoing description provides examples of the disclosed system and technique. However, it is contemplated that other implementations of the user interfaces of this disclosure may differ in detail from the foregoing examples. All references to the user interfaces of this disclosure or examples thereof are intended to reference the particular example being discussed at that point and are not intended to imply any limitation as to the scope of the user interfaces of this disclosure more generally. All language of distinction and disparagement with respect to certain features is intended to indicate a lack of preference for those features, but not to exclude such from the scope of the user interfaces of this disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A display device for displaying a graphical user interface of a management system, the graphical user interface comprising:
a first screen configured to display a first panel including equipment information; and
one or more selection tabs or links configured to access at least a second screen, the second screen being configured to facilitate management of one or more pieces of equipment associated with the management system,
wherein the first panel is configured to display equipment summary information.

2. The display device for displaying a graphical user interface of claim 1, wherein the first screen includes at least a second panel configured to display alert information based on an alert type.

3. The display device for displaying a graphical user interface of claim 1, wherein the first screen includes at least a second panel configured to display alert information based on a count of alerts in different alert type subcategories, the alert type subcategories including one or more of geographic boundaries, fault codes, engine status, power loss, device status, and battery voltage.

4. The display device for displaying a graphical user interface of claim 1, wherein the second screen includes a chart of equipment arranged according to a sortable header, the header including one or more of the following categories: equipment identification, serial number, make, model, date last reported, hours, last reported status, alert count, last reported location, and last reported location time stamp.

5. The display device for displaying a graphical user interface of claim 4, wherein a column of the chart of equipment relating to equipment identification may include an icon associated with a piece of equipment.

6. The display device for displaying a graphical user interface of claim 5, wherein the icon has a height of between 60 to 70 pixels, and a width of between 40 to 50 pixels.

7. The display device for displaying a graphical user interface of claim 5, wherein the icon includes a selectable sidebar configured to display sub-equipment in the chart of equipment.

8. The display device for displaying a graphical user interface of claim 7, wherein the sub-equipment is displayed in a row or rows directly below a row of the icon including the selectable sidebar.

9. The display device for displaying a graphical user interface of claim 1, the graphical user interface further comprises one or more selection tabs or links configured to access at least a third screen, the third screen being configured to facilitate management of alert rules for the one or more pieces of equipment.

10. The display device for displaying a graphical user interface of claim 1, the graphical user interface further comprises one or more selection tabs or links configured to access at least a fourth screen, the fourth screen being configured to facilitate management of view assignments for the one or more pieces of equipment.

11. A computer-implemented method for displaying a management system through a user interface, the method comprising:
retrieving information from one or more pieces of equipment associated with the management system;
generating a first screen to display a first panel including equipment information;
generating the first screen to display one or more selection tabs or links configured to access a second screen to facilitate management of one or more pieces of equipment associated with the management system; and
wherein the first panel displays equipment summary information.

12. The method of claim 11, wherein generating the first screen includes generating a second panel configured to display alert information based on an alert type.

13. The method of claim 11, wherein generating the first screen includes generating a second panel configured to display alert information based on a count of alerts in different alert type subcategories, the alert type subcategories including one or more of geographic boundaries, fault codes, engine status, power loss, device status, and battery voltage.

14. The method of claim 11, further comprising generating the second screen,
wherein the second screen includes a chart of equipment arranged according to a sortable header, the header including one or more of the following categories: equipment identification, serial number, make, model, date last reported, hours, last reported status, alert count, last reported location, and last reported location time stamp.

15. The method of claim 14, wherein a column of the chart of equipment relating to equipment identification may include an icon associated with a piece of equipment.

16. The method of claim 15, wherein the icon has a height of between 60 to 70 pixels, and a width of between 40 to 50 pixels.

17. The method of claim 15, wherein the icon includes a selectable sidebar configured to display sub-equipment in the chart of equipment.

18. The method of claim 17, wherein the sub-equipment is displayed in a row or rows directly below a row of the icon including the selectable sidebar.

19. The display device for displaying a graphical user interface of claim 1, wherein generating the first screen to display includes generating one or more selection tabs or links configured to access at least a third screen, the third screen being configured to facilitate management of alert rules for the one or more pieces of equipment.

20. The display device for displaying a graphical user interface of claim 1, wherein generating the first screen to display includes generating one or more selection tabs or links configured to access at least a fourth screen, the fourth screen being configured to facilitate management of view assignments for the one or more pieces of equipment.
